(19) United States
(12) Patent Application Publication
(10) Pub. No.: US 2014/0352854 A1
(43) Pub. Date: Dec. 4, 2014

(54) POWDERED FUEL PRODUCTION METHODS AND SYSTEMS USEFUL IN FARM TO FLAME SYSTEMS

(71) Applicants: Ken W. White, Ithaca, NY (US); Edward Bacorn, Lansing, NY (US)

(72) Inventors: Ken W. White, Ithaca, NY (US); Edward Bacorn, Lansing, NY (US)

(21) Appl. No.: 14/462,794

(22) Filed: Aug. 19, 2014

Related U.S. Application Data
(63) Continuation of application No. 13/214,803, filed on Aug. 22, 2011, now abandoned.
Application No. 13/214,803 is a continuation of application No. 13/001,549, now abandoned.
(60) Provisional application No. 61/076,640, filed on Jun. 28, 2008.

(51) Int. Cl. C06B 45/00; B02C 23/08; B02C 23/12; B02C 13/00

(52) U.S. Cl. CPC C06B 45/00; B02C 13/00; B02C 23/08; B02C 23/12
USPC 149/2

(57) ABSTRACT

The present invention relates to a method of preparing an explosible powder suitable for combustion in an oxidizing gas. This method involves providing a biomass feedstock material and drying the biomass feedstock material to a moisture level of less than or equal to 10%. The dried biomass feedstock material is milled to form an explosible powder suitable for combustion when dispersed in an oxidizing gas. A system for carrying out this method is also disclosed.

This application is a continuation of U.S. patent application Ser. No. 13/214,803, which is hereby incorporated by reference in its entirety and is a continuation of U.S. patent application Ser. No. 13/001,549, filed Jun. 29, 2009, which is hereby incorporated by reference in its entirety and claims benefit of a national stage application under 35 U.S.C. §371 from PCT Application No. PCT/US2009/049074, filed Jun. 29, 2009, which is hereby incorporated by reference in its entirety and claims benefit of U.S. Provisional Patent Application Ser. No. 61/076,640, filed Jun. 28, 2008, which is hereby incorporated by reference in its entirety.

### FIELD

The present invention relates to powdered fuel production methods and systems useful in farm to flame systems.

### BACKGROUND

Scientists and engineers have toiled for decades to discover workable alternatives to petroleum-based fuels. Despite this prolonged effort, such alternatives have failed to gain commercial success. However, this failure can hardly be attributed entirely to economic conditions. Indeed, market conditions have been favorable to petroleum alternatives, particularly in times of oil shortages such as during World War II and the 1970's energy crisis.

The lack of commercial success of alternative fuels may be explained, at least in part, by the shortcomings of prior systems. One of the major drawbacks of prior systems and methods of utilizing alternative fuels is the inability of the systems to provide the operational benefits of petroleum-based systems. For example, pellet-burning wood stoves and coal-fed cyclone furnaces lack the on/off functionality of gas and oil burners. The furnace will continue to burn the fuel added to the burner chamber until the fuel is consumed regardless of whether the desired temperature is reached. Likewise, existing pellet- and power-based systems lack the ability to quickly respond to increased performance demands due to the “ramp up” time required to ignite the newly added fuel.

Moreover, the disadvantages of existing alternative fuel systems can be staggering. These systems often produce pollution that is worse than that produced by petroleum-based systems. For example, existing wood boilers produce unpleasant odors and large particulates that can irritate the lungs and eyes. See, e.g., Anahad O'Connor, “Wood Boilers Cut Heating Bills The Rub? Secondhand Smoke,” N.Y. Times (Dec. 18, 2006). Additionally, these systems may not even produce the proper conditions for efficient combustion, for example, resulting in excess carbon monoxide production.

As the existing technology has been clearly inadequate to produce an alternative fuel system, there still remains a need for clean, dependable, and efficient alternate fuels, in addition to the systems that utilize alternate fuels. The present invention is directed to overcoming the deficiencies in the art.

### SUMMARY

One aspect of the present invention relates to a method of preparing an explosible powder suitable for combustion in an oxidizing gas. This method involves providing a biomass feedstock material and drying the biomass feedstock material to a moisture level of less than or equal to 10%. The dried biomass feedstock material is milled to form an explosible powder suitable for combustion when dispersed in an oxidizing gas.

Another aspect of the present invention relates to a system for preparing an explosible powder suitable for combustion when dispersed in an oxidizing gas. This system includes a drier for drying a biomass feedstock material to a moisture level of less than 10% and one or more mills for milling the dried biomass feedstock material to form an explosible power of particulate size suitable for substantially complete combustion in an oxidizing gas.

The method and system of the present invention are useful in the cost effective manufacture of one or more of the radically new explosible powder based fuels. While minimizing energy input per pound of powder, this large, energy intensive intelligent hardware apparatus receives raw biomass, corn stalks, or wood chips as well as other energy fuels and converts them into an explosible powder fuel.

The system of the present invention, after referred to as an “Explosible Powder Production Module” (EPPM) or PPM, can be geographically located to serve a few county local area and is connected to a surrounding network of EPPM's. This forms a flexible and intelligent, demand and supply driven larger production EPPM, to produce the explosible energy powder. This network design and sheer geographic size is analogous to the nation's power grid.

### BRIEF DESCRIPTION OF THE DRAWINGS

FIG. 1 graphically depicts a regional or global network of interconnected EPPM's, the GPPM, to handle the business operations of raw material supply and distribution to accommodate demand pressure.

FIG. 2 shows diagrammatically how EPPM production is integrated with biomass production, fuel distribution, and typical end uses.

FIG. 3A shows schematically explosible and non-explosible particle size distributions.

FIG. 3B shows an ideal particle size distribution and a more typical distribution for explosible fuels.

FIG. 3C shows three different shapes of explosible powder distributions and blends.

FIG. 4A depicts a basic feedback control block diagram to control operations within the EPPM apparatus.

FIG. 4B block diagram depicts the Markov Decision Process, a typical advanced, high level control strategy for the EPPM.

FIG. 5 shows the raw material receiving, preprocessing, and sorting for initial particle size reduction operations to the input specifications of the EPPM.

FIG. 6 shows the EPPM process steps from presized green raw material through initial Step 0 size reduction to mill input specification, raw material drying, and size screening.

FIG. 7 is a block diagram which depicts both Step 1 and Step 2 impact grinding (i.e., hammermill steps 1 and 2) operations through medium fine grind screening particle size classification.

FIG. 8 shows the final stages of the EPPM process from Step 3 fine grind pulverizing and air classification through intermediate powder grade storage, finished product blending, storage, and shipment.

FIG. 9 is a diagram illustrating the steps of pelletizing material from the EPPM process.

### DETAILED DESCRIPTION

### I. Introduction

Improvements in efficiency, automation, and flue gas pollution reduction of heating and energy conversion systems have been ongoing, in an incremental and evolutionary, not revolutionary fashion. Beyond the development of the separate nuclear power generation industry, no radical departures have occurred in the last half century. Only in the last decade has the rate of introduction of sporadic alternative renewable, sustainable and environmentally friendly energy sources and generation mechanisms begun to climb significantly. These include the addition of devices to capture wind power, solar power (solar cells and thermal heat energy capture), wave energy, hydroelectric flow, methane gas from anaerobic bacterial decomposition, biochar and a limited number of small co-firing uses of some forms of biomass. The problems with diversion of food crops to energy uses, for example corn to produce ethanol as a gasoline additive, has recently come to public attention due to the major resulting upsets in the agricultural and food supply industries which in turn have had a ripple effect on costs throughout the US economy and supply chains. Recently, a nearby ethanol facility went bankrupt.

It is now time for a sea change, which will provide for a major reduction in most countries' dependence on fossil fuels, primarily oil, and the opportunity for local production and distribution of renewable biomass energy fuel to fill in this gap, without the introduction of significant quantities of “new” CO₂ into the atmosphere. As such, the present invention provides for the complete production process of a solid fuel in the form of an explosible powder, which when dispersed within with an oxidizing gas in a suspension, produces heat or performs work.

An overall system design goal for EPPM of the present invention is to accept a diverse and number of varying energy fuel raw material input streams and to output powder energy products, well controlled to meet end use specifications. The EPPM must be responsive to changes in raw material and their inherent variability, while meeting both constant and varying final product type and volume demand requirements.

Development of an entirely new vertical industry, utilizing the most truly distributed production system imaginable, makes it possible to design a local, area, state, regional, national, and international engine, comprised of discrete machines that are truly responsive to disturbances on both the demand and supply side. The virtual production system, in networked form, then becomes the size of the highest level of geographic integration of discrete EPPM's that currently exists. It is not difficult to envision a state, regional, national or even continental EPPM network production engine, meeting the energy production needs of all in its area of coverage.

Driven by an economic strategy that takes into account local & regional demand, biomass source reshipment, demand driven local blending and output product grade shipment (transshipment) to other EPPM distribution facilities is anticipated by the EPPM owner or their agents, to enable through the network to meet dynamic changing needs.

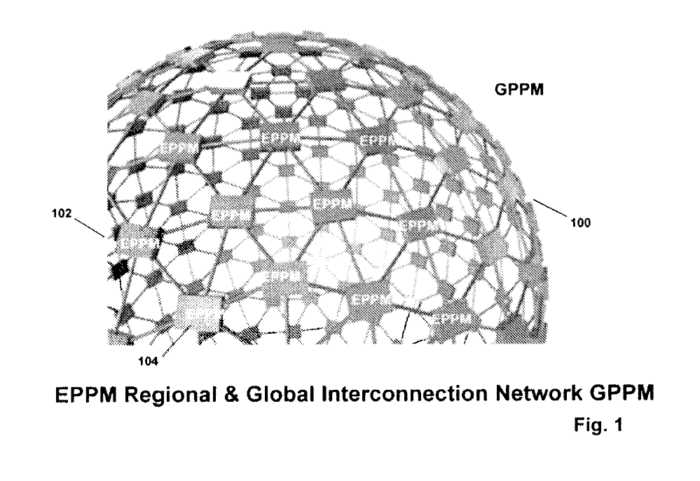

For example, while individual EPPM's may each (or in groups) be owned by different parties, they participate as part of the whole, the larger production system engine referred to as the Global Explosible Powder Production Module (GPPM) in a material and financial cooperative type of arrangement. Each of the discrete EPPM's 102 and 104 is tied through the internet or other connection means with all operational business, production, capacity and inventory data shared as 100 diagrammatically depicted in FIG. 1. The latest real-time manufacturing targets at any local EPPM 102 would reflect the needs of the larger engine as a whole. Transshipments, if required perhaps by nearby 104, are automatically scheduled, executed, and paid for at dynamically adjusted inter-EPPM market rates, taking all data including shipping supply chain realities into account. This system serves the interests of all involved. If by accident or disaster all inter-engine connections arc broken, every local EPPM engine, while becoming less efficient with economic scale loss, continues to perform and meet its local/regional demand adequately as a free standing production machine, driven by free market forces locally.

### II. Definition of Terms

The term “air classifier” as used herein utilizes air flow to separate light from heavier particles often using a variable speed direct drive classification wheel to adjust separation size cut points. There are several types including turbine air classifiers which produce cut points that are not feed rate dependent. Air classifiers can often be used as an alternative to filters when the particles are transported by air.

The term “ash” as used herein describes the incombustible remains of combustion.

The term “ball deck” as used herein is part of a screener apparatus that may be located below a screen housing captive balls to constantly strike the lower side of a screen to assist keeping it clean by dislodging wedged-in particles or near size plugs.

The term “biochar” as used herein is a charcoal produced from biomass. In some cases, the term is used specifically to mean biomass charcoal produced via pyrolysis. It is a significant co-product of the pyrolysis process having properties comparable to coke and is virtually sulfur free. At 28-29 GJ per ton, pyrolysis biochar has a higher heating value than many grades of coal, yet is a fuel that is CO₂ neutral.

The term “biomass” as used herein describes any organic matter available on a renewable or recurring basis, i.e. complex materials composed primarily of carbon, hydrogen, and oxygen that have been created by metabolic activity of living organisms. Biomass may include a wide variety of substances including, but not limited to, agricultural residues, such as grasses, nut hulls, oat hulls, corn stover, sugar cane, and wheat straw, energy crops, such as grasses including but not limited to pampas grass, willows, hybrid poplars, maple, sycamore, switch grass, and other prairie grasses, animal waste from animals, such as fowl, bovine, and horses, sewage sludge, hardwood or softwood residues from industries such as logging, milling, woodworking, construction, and manufacturing, and food products such as sugars and corn starch.

The term “blended powdered fuel” as used herein describes a powdered fuel that comprises two or more distinct powdered fuels, each of which may vary in particle size, material, or composition, and may contain the same or different raw material sources.

The term “BTU content” as used herein describes the amount of energy in British Thermal Units produced when a fuel combusts.

The term “burner” as used herein is generic to “burner assembly”, “burner head”, and “flame holder” and describes a device by which fluent or pulverized fuel is passed to a combustion space where it burns to produce a self-supporting flame. A burner includes means for feeding air that are arranged in immediate connection with a fuel feeding conduit, for example concentric with it. The expression “burner” is often used instead of “combustion apparatus” and is not used in the restricted meaning above.

The term “classifier mill” as used herein provides both size reduction integrated with particle size classification. The classification wheel is usually driven by a separate adjustable speed drive. Operating to balance centrifugal force against drag force and gravity, this type of classifier provides a high precision, repeatable method to classify particles by size and density.

The term “cleaning” as used herein describes the dislodging of extraneous matter or incrustations.

The term “closed loop system” as used herein describes a system in which a result is monitored for deviations from a desired value and one or more inputs are adjusted to minimize the deviations.

The terms “combustion” and “combust” as used herein, without reference to a type of device, i.e., a combustion device, describe the act of deflagration. These terms are distinguishable from the act of simple burning, which is the direct combination of oxygen gas and a burnable substance.

The term “controlled”, as used herein in the term “controlled quantity,” describes the characterization of a parameter that is capable of being modified, e.g., finely or coarsely, through the use of a feedback loop of information. For example, the term “controlled quantity” refers to the quantity of a measurement that is selected based on feedback modification, e.g., a feedback loop of information.

The term “converting” as used in the term “converting energy” is used herein to describe the act of harnessing or utilizing, for example, energy, to produce a result, such as doing work or producing heat. In certain embodiments, the conversion of the energy may occur through the operation of a device, as measured by the action of the device, i.e., which will produce a measurable result.

The term “coupled” as used herein describes the connection of two or more components by any technique and/or apparatus known to those of skill in the art. Coupling may be direct with two components in physical contact with each other or indirect with a first component in physical contact with one or more components that are in physical contact with a second component. For example, in the expression, “the input of the Step 3 classifying mill is coupled to the hammer mill screener output to receive the oversized particles for further reduction.”

The term “deagglomeration” as used herein describes the act of breaking up or removing large particles comprised of groups of smaller particles self-adhering in clumps.

The term “explosible” as used herein describes a property of a powder with a particle size distribution below a material specific threshold (˜200μ for wood), which, when dispersed under the appropriate conditions as a powder-gas mixture, is capable of deflagrating flame propagation after ignition. Explosible powders that form explosible powder dispersions are capable of flame propagation when mixed at the appropriate ratio of an oxidizing gas, at an equivalence ratio 11 ranging from slightly less than 1 to 10. Numerous explosible powders, which are distinguishable from ignitable powders, are described in R. K. Eckhoff, Dust Explosions in the Process Industries, 3rd Edition, Elsevier (2003) in Table A.1.

The term “explosion containment” as used herein, describes a type of heavy walled equipment design intended to withstand an internal dust explosion, commonly 10-100+bar. 3 bar “explosion resistant” designs are used where pressure relief facilities are provided.

The term “hammer mill” as used herein describes a mechanical device using rotating hammers and stationary anvils to smash, crush, and tear large biomass pieces into smaller fragments. A stationary perforated screen provides an exit path for reduced particles. By its very nature, a hammer mill is a “large fan.”

The term “heated apparatus” as used herein describes any apparatus, for example air heaters, water heaters, boilers, and heat exchangers, that uses the heat generated by combustion and has a primary function other than mere facilitation of the combustion process or its completion.

The term “hog fuel” as used herein describes biomass fuel that has been prepared by processing through a “hog” or mechanical shredder or grinder. If produced by primary forest industries, hog fuel usually contains a mixture of bark and wood often with sawdust, shavings, or sludge mixed in and is generally wet and fibrous with a high ash content. Flog fuel may also be produced from secondary materials such as pallets or construction or demolition wood yielding a dry, mostly wood fuel but often with significant inorganic contaminants.

The term “lignocellulosics” as used herein describes biomass that is composed primarily of cellulose and lignin, the structural component of plants created by photosynthetic activity.

The term “mesh” as used herein describes particle size by comparison to the open spacing of particle sieves as defined by a specific standard of mesh. A variety of standards for mesh scales exist, including ISO 565, ISO 3310, and ASTM E 11-70. All mesh sizes as used herein are measured using the ASTM E 11-70 standard.

The term “mill” as used herein refers to an apparatus or process to grind, pulverize, or break down into smaller particles. Some types of mills used in the bulk powder industry for particle size reduction are referred to as grinding mills, pulverizing mills, pin mills, disk mills, attrition mills, impact mills, classifying mills, powderizing mills, amongst others.

The term “moisture content” as used herein describes the weight of water in a unit of biofuel, usually expressed as a percentage of the total sample weight.

The term “particle size” as used herein describes the size of a particle, e.g., in terms of what size mesh screen the particle will pass through or by metric description of the size (e.g., in microns). Moreover, certain embodiments of the powdered fuel are defined, in part, by particle size. Particle size may be defined by mesh scales, in which larger numbers indicate smaller particles.

The term “particle size distribution” as used herein is a statistical term with numerous descriptors for a curve which describes the prevalence of particles of various size ranges, i.e., the distribution of the particles of various sizes, within a powder sample.

The term “particulate” as used herein describes very fine solid particles, typically ash plus unburned carbon that are entrained by the combustion gases and escape to atmosphere. Usually the main air pollutant from biomass combustion.

The term “plastic” as used herein describes synthetic or semisynthetic polymerization products including, but not limited to, polypropylene, polystyrene, acrylonitrile butadiene styrene (ABS), polyethylene terephthalate, polyester, polyamides, polyurethanes, polycarbonate, polyvinylidene chloride, polyethylene, polymethyl methacrylate, polytetrafluoroethylene (PTFE), polyetheretherketone (PEEK), polyetherimide, phenolics, urea-formaldehyde, melamine formaldehyde, and polylactic acid. As used herein, “plastic” includes the general categories of both recyclable and non-recyclable plastics.

The term “powder” as used herein describes a solid compound composed of a number of fine particles that may flow freely when shaken or tilted. The powder composition, particulate size, or particle size distribution and its accompanying descriptive statistical parameters for the curve (mean, median, mode, standard deviation, etc.) may be selected based on the application in which the powder is being used.

The term “powdered” as used herein describes a substance that has been reduced to a powder.

The term “powdered fuel” as used herein describes a combustible solid fuel, reduced in mean particle size to a point where the substantial majority of particles are below its particular explosible threshold and is used interchangeably herein with the terms “explosible powder”, “powder”, and “fuel”.

The term “pulverize” as used herein means to pound, crush, or grind a larger particle size substance into a dust.

The term “pulverized coal” as used herein describes conventional ground coal that typically has a product fineness of 70% through a 200-mesh sieve and less than 3% surface moisture. This is the cheapest form of fine granular coal for use in advanced coal-fired combustors.

The term “purging” as used herein describes the removal of unwanted material.

The term “size reduction” as used herein describes the function of processing large particles into smaller ones through a variety of mechanisms such as shredding, tearing, milling, attrition, pulverizing, grinding, impacting, and other energy intensive operations.

The term “ultra clean coal” as used herein describes any coal having a low ash content by weight, for example, less than 1%.

The term “ultrafine coal” as used herein describes a product of an integrated process comprising grinding, drying, and beneficiation and is used interchangeably herein with the terms “dry ultrafine coal” and “DUF”. Ultrafine coal is thus a fine powder with low ash and sulfur content and is more expensive than dry pulverized coal. Often mixed with water, for safety and handling benefits, plus stability enhancing and flow improvement chemicals.

The term “volatile mass” as used herein describes the mass of the powder fuel particles that includes material or compounds, such as water, which vaporize or volatilize at or below the combustion temperature of the powdered fuel.

The term “wood flour” as used herein is a finely pulverized wood that has a consistency fairly equal to sand, but may vary considerably, with particles ranging in size from a fine powder to roughly the size of a grain of rice. Most wood flour manufacturers are able to create batches of wood flour that have the similar consistency. All high quality wood flour is made from hardwoods due to its durability and strength. Very low grade wood flour is occasionally made from sapless softwoods such as pine or fir.

### III. Methods and an Apparatus for Manufacturing Powdered Fuel

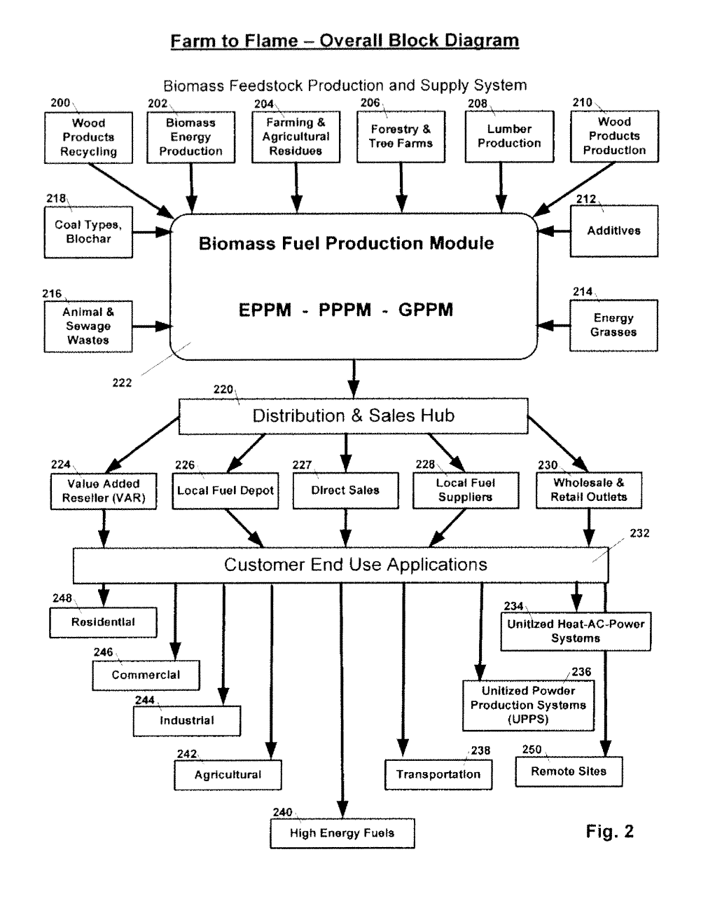

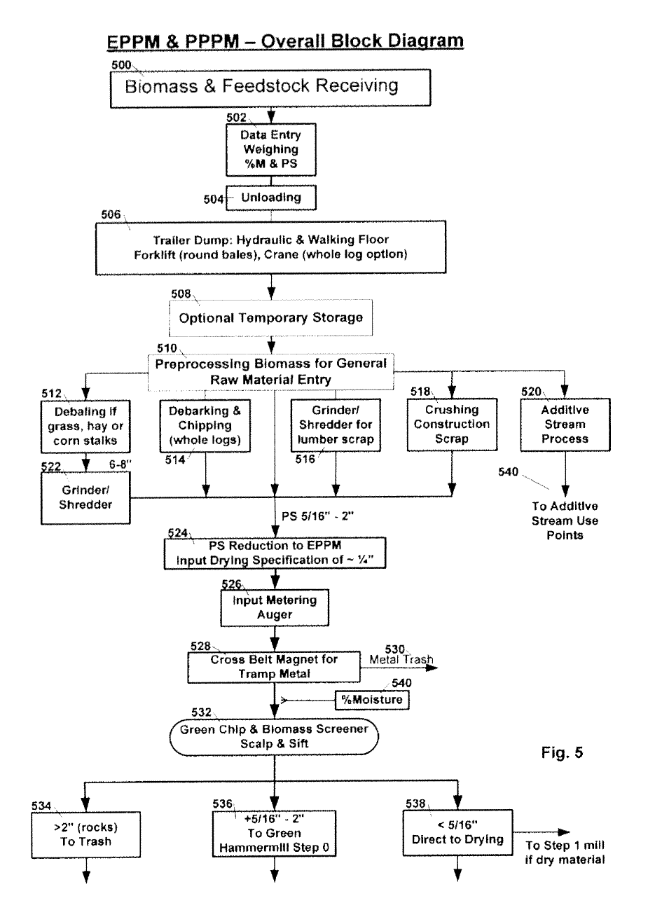

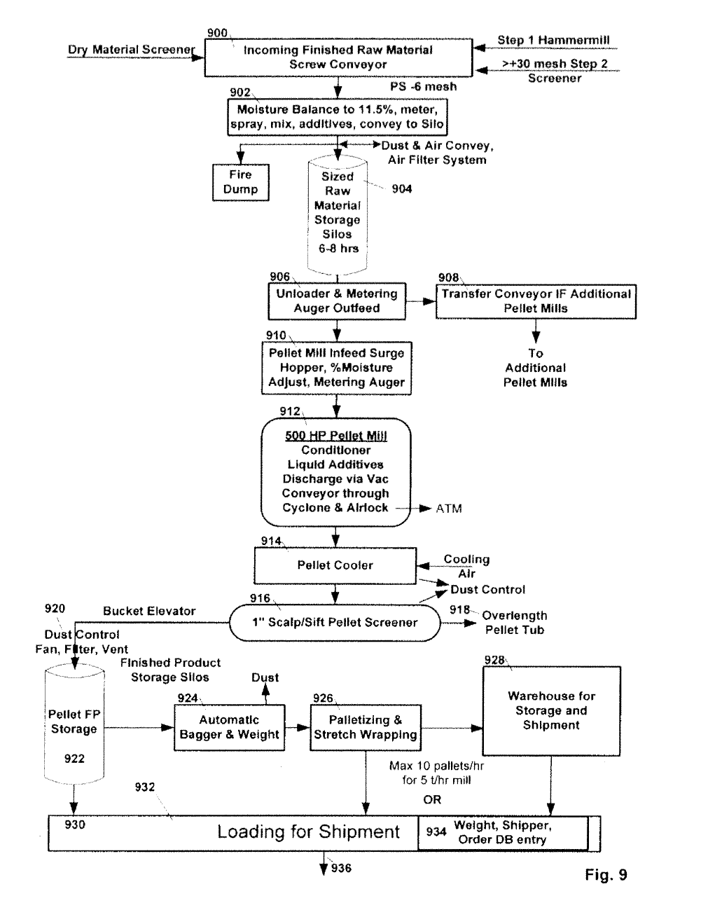

This disclosure details the operation of four (4) major activity blocks depicted and labeled in FIG. 2, the Farm to Flame Overall Block Diagram. It begins at the raw material production or supply side end of the process, depicting 10 of many sources of biomass supply 200-218. It then fully describes and discloses the system, means, methods, apparatus and process control techniques for powdered fuel manufacturing production comprising the EPPM 222. This module, further detailed by system process steps in FIGS. 5-8, operates in a manner which meets and maintains product specifications, through a unique combination of intermediate stages, ending with final product blending. FIG. 9 details additional process steps resulting from the integration of pelleting operations with the EPPM, comprising an energy fuel process with better economics and wider product range called the Pellet and Powder Production Module (PPPM). Beyond the output of the EPPM, energy product distribution methods 220-230 are disclosed and described, followed by a listing of typical end user applications 232-248 and the specific processes and control systems that support them.

Coupled with this new manufacturing process is a disclosure of the system techniques and methods which connects powdered fuel production demand into an existing raw material supply side system. Likewise, the unique energy production process inside the EPPM also plugs its output into an existing energy distribution system, also slightly altered by new product streams, to supply an existing and new customer base. Energy powder customers will require the installation of new combustion and fuel storage hardware into existing (or new) heat utilizing hardware, to be manufactured and supplied by its own existing vertical equipment industry.

### The Biomass Supply Stream

Crops such as fast-growing trees and grasses, are called energy crops when used as biomass feedstock. For countries with predominant agriculture, the use of biomass as a fuel can generate rural employment and improve local economy of energy users Biomass must now be considered a resource for transportation, biopower for electricity generation, and use of biorefinery products, for there is worldwide-rekindled interest in biomass energy, all without knowing of the technology of the present invention.

A wide range biomass sources are commonly available. Certain grasses are already referred to as “energy grass.” Biomass feedstock material is selected from the group consisting of crops, wastes and residues, starch crops, grains, rice, barley, rye, oats, soybean, maize and wheat, sugar cane, sugar, cocoa bean, sugar crops, corn, grasses, switchgrass, Miscanthus grass, elephant grass, Orchardgrass, many perennial grasses including Timothy grass tall fescue, prairie grass, Abfrageergebnisse (offered for license by a Hungarian research institute as “energy grass”), Reed canarygrass, industrial hemp, Giant reed, cotton, seeds and husks, seaweed, water hyacinth, algae, microalgae, herbaceous and woody energy crops, wood chips, bamboo, wood, stem wood, cellulose, and lignin, hardwoods, American sycamore, black locust, eucalyptus, hybrid poplar, hybrid willow, silver maple, softwoods, cedar, pine, Monterey pine, invasive types of brush, fishmeal, fat, whey, agricultural wastes, rice straw, chaff, wheat straw, sugar cane bagasse, corn stover, corn stalks, biochar and forestal wastes, sawdust, shavings, lumber wastes, pulp and pulp waste, mill wastes, thinned woods, brush, municipal and industrial solid wastes, construction wastes, demolition wood wastes, urban wood wastes, yard wastes, agricultural residues, livestock wastes, dry manure solids, poultry wastes, intermediate enzymatic and acid hydrolysis bio-solid byproducts, and waste solids from biological processes of ethanol fermentation, methane production, and anaerobic digestion.

### Energy Yield Examples

A dry ton of wood chips represents about the chemical energy equivalent of 100 gallons of heating oil. Similar relationships exist for all types of biomass input. However, to simplify the discussion, assume: 1 dry ton biomass˜100 gallons of fuel oil BTU equivalent.

From a farm acreage perspective, it is reasonable to expect the following yields in Table 1 for types of biomass grown in appropriate regions.

TABLE 1

| | | Heating φ \| | | |
|---|---|---|---|---|
| Typical Yield: | Biomass | Equivalent yield per | | |
| dry tons/acre | Type | acre | | Comments |
| 16 | Miscanthus | 1700 | gallons | aka Elephant Grass |
| | Grass | | | |
| 10 to 30 | Miscanthus | 1000-3000 | gallons | 25 dt/acre in Alps |
| | Grass | | | lowlands, similar in |
| | | | | US Midwest |
| 16 | Bamboo | 1600 | gallons | |
| 10 | Industrial | 1000 | gallons | |
| | Hemp | | | |
| 7 | Switchgrass | 700 | gallons | |
| 6 | Willow | 600 | gallons | |
| 5 | Hay | 500 | gallons | |

Biomass energy conversion principles are driven by a fuel that is carbon neutral (some carbon negative), renewable, sustainable, locally produced, low cost, with near 100% complete combustion, smoke and soot free plus is “green” for it introduces no new CO₂ into the atmosphere beyond harvesting and some percentage of processing.

By comparison, biodiesel costs about six (6×) times the amount to produce than using explosible powdered fuels directly from biomass for the same recoverable BTUs. Biodiesel has an upper limit of 40-50 gallons/acre/year. About 80% of the energy value in sugar cane has been unused in the past, with much “burned off” in the field. Today in Brazil, ethanol is a likely outcome for this “bio-scrap.” And to put corn based ethanol in perspective, even beyond the fact that a “food” crop does not belong in the energy chain, using our EPPM process to fuel the burners of the present invention, more energy value can be recovered from what is left behind in the cornfield (stalks), than is recovered from the ever more costly conversion of the corn to ethanol.

Biomass fuel sources, non-biomass fuels and additives are received at the EPPM depicted in FIG. 2 as items 200-218. The main initial sources planned are from Forestry & Tree Farms 206, Lumber & Wood Products Production 208 and 210, Energy Grasses 214, and Farming and Agricultural Residues 204. Others will be added based on regional availability, fuel grade demand, and economic return on investment capital for specialized receiving hardware sub-systems.

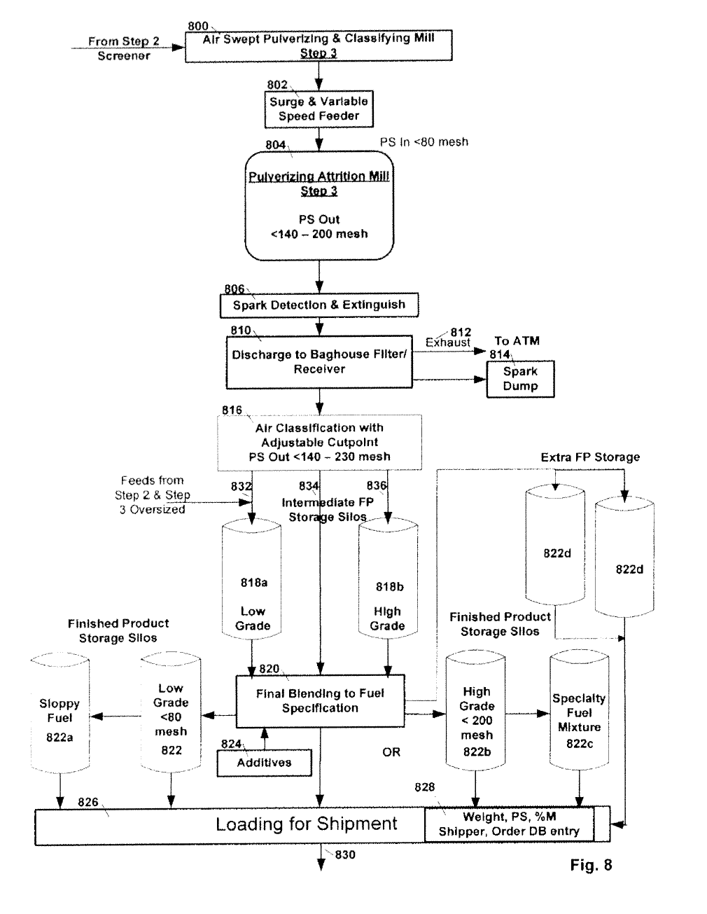

For example, in areas with large dairy production, use of manure and post anaerobic digestion dry manure solids 216 provides a very low cost energy input stream of above average ash content. Currently, a disposal burden, 6600 tons for a 1000 head dairy for example, these dry manure solids may be delivered to or picked up by the local EPPM to produce a high ash fuel. Similarly, only some regions have scrap sources from Wood Products Recycling 200, Lumber 208, and Wood Products Production 210. Crushers and grinder/shredder options would accommodate these mostly dry raw material input streams. Various types of coal 218, with a range of calorific energies, sulfur content, and the like are available and in demand in certain regions Ultra-clean coal and biochar 218 are energy sources that have yet to see significant demand, yet offer an opportunity for Specialty Fuel products 822c in FIG. 8. Additives 212 represent both solids and liquids that are useful in blend combustion performance enhancement and control.

Another overall system embodiment is comprised of a complete biochar production facility integrated with an EPPM or PPPM, as it would offer further fuel and energy source advantages. While the total production costs of biochar have not yet been completely determined, use of the “free energy” of pyrolysis in its production is useful for the biomass drying operation. Biochar has a higher heating value than coal, is structurally similar and easy to pulverize, much easier than most biomass reduction, yet is CO₂ neutral. Reduction of biochar fits within the design plans for the Additive Stream 520. With these attributes, biochar becomes a candidate as an additive for Specialty Fuels, from minor to significant.

The cost of reducing a solid fuel from a non-explosible form, to a particle size that renders it “explosible”, is small compared to the cost to convert it to a real liquid or gaseous fuel. Also, any biomass or chemical solid fuel source, can, by reduction to a particle size below its specific critical value, be considered an “explosible” powder. All biomass BTUs produced on an acre can be used, yielding tremendous efficiency.

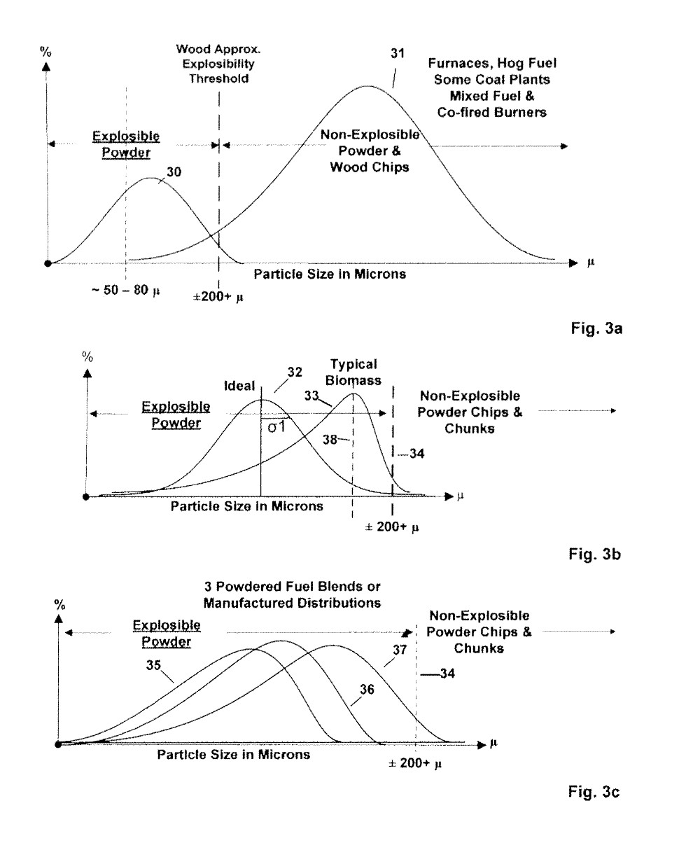

FIG. 3A shows two curves 30, 31, conceptually depicting two particle size distributions. The powdered fuel energy conversion process of PCT Patent Application No. PCT/US2007/024044, which is hereby incorporated by reference in its entirety, uses a substantially explosible powder as a fuel, with particle sizes from, for example 50 microns or less, up to the region surrounding the material's explosibility limit of +/−200 microns for wood, as seen in the left hand curve 30.

Particles much larger than 200+ micron limit are not typically explosible, burning more slowly and hence non-explosively in a common two phase regime. 200 microns is an approximate limit for particle size for wood. This upper limit may vary for different types of biomass and other explosible powders based on particle surface-to-volume ratios, particle aspect ratio, percent moisture, percent volatiles, calorific value of the powder/dust, temperature, dispersion concentration and uniformity, particle internal structure morphology, and the like.

The distribution 31 on the right of FIG. 3A includes a wide range of particle sizes, with a predominant membership in the non-explosible range. Wood chips, saw dust, ground waste, hog fuel, crushed coal, and other combustible biomass up to whole trees and hydrocarbon based fuels have been burned in large furnaces for boilers, power plants, and other common modes for years. More recently, mixed fuel and co-fired burners and combustion schemes have been used for predominantly non-explosible dusts and powders.

FIG. 3B depicts an ideal particle size distribution 32 centered around the 50-80 micron mean, and a more typical curve 33 found in various types of substantially explosible fuels from biomass and other powdered sources. This curve 33 is skewed heavily to the right, toward a mode with larger particles than the mean or median would indicate, yet is still within the explosible region. The shape of this distribution is skewed primarily based on manufacturing processes and cost minimization controls utilized within the EPPM of the present application, knowing that every time the particle size is halved, the energy requirement doubles.

As with all manufacturing processes, there tends to be a statistically allowable minor portion of the overall distribution which may fall just outside the desired region. This amount is a somewhat adjustable quantity depending on economic throughput models combined with the reproducibility of the manufacturing and separation equipment. For some uses, control of this right hand tail of the curve accounts for different quality levels or grades of fuel. If a few percent (max 5%) of the particles are over the explosibility size limit (threshold)—referred to herein as “sloppy fuel.” Certain industrial heating uses can tolerate cleanup and removal of slightly oversize unburned particles for a lower priced fuel.

Three different skewed shapes of substantially explosible powder distributions 35, 36, 37 are depicted in FIG. 3C. The particle size distributions for embodiments of the present invention herein may have a variety of statistical characteristics, based on uses and economics discussed above, and the grades below.

U.S. Pat. No. 4,532,873 to Rivers et al., which is hereby incorporated by reference in its entirety, describes a suitable system, according to the present invention, for direct burning various types of reduced but primarily non-explosible particle size biomass for heat recovery, in this case a water-wall boiler.

### Burner Operation and Powder Combustion Process

Most burner designs are essentially uncomplicated steel cylinders reminiscent of an 8″ stovepipe 1-2 feet in length, with an air-fuel nozzle entering the center of the closed end base, recirculation air entering through sidewall holes near the base, and additional secondary air injected ⅔ of the way toward the open exit to complete the combustion. The process described below allows harnessing long feared dust explosions, the missing link in biomass energy conversion.

In one embodiment, a powder is fed from the base of a horizontal auger, mixed with turbulent air to form a dispersion, then that powder-air mixture is fed through a nozzle into the burner at a concentration 3-4 times stoichiometric, all at a velocity just above the premix flame speed, in the range of 1-2 meters per second. Combustion occurs instantly as a standing wave front inside the burner, balanced on the slowing and widening powder dispersion where its concentration is lessened and turbulent mixing occurs through recirculation.

This First stage, preheat zone I, heats the solids in the dispersed phase. The flame front is the transition line into Reaction Zone II, where heating of the gas is the primary dynamic. A continuous gas-particle conductive heat transfer between preheat zone I and reaction zone II continues, as a fresh supply of explosible powder particle reactants are continuously fed into burner for deflagration.

Oxygen is depleted somewhere in the reaction Zone II, while hot particles still at combustion temperature continue moving toward the open exit. The second stage begins with the introduction or high-speed secondary air at an angle to encourage mixing with a velocity perhaps 10 times the flame speed. This additional final oxidizer drives char burnout to completion, a fast process that occurs in a time related to the particle radius squared (R²), rather than just R as in the first stage.

This green process for burning a solid is instant ON/OFF like traditional liquid and gas fossil fuels, but without introduction of new CO₂ into the atmosphere. Due to the completeness of this combustion method, there is no smoke or smell in the flue gas. Volatile organic compounds (VOC's) are substantially lower than all other methods combustion methods for wood, coal and other biomass, including today's most highly automated, least polluting industrial natural gas burners.

Fuel Grades: All forms of biomass are a potential fuel source, and become a useful commodity when converted to a substantially explosible powder. As with most fuel sources, there are variations in power output depending, on the mix of the fuel raw material input and its processing. Powdered biomass has similar properties. Depending on the type of biomass being used (corn stalks, grass, hay, wood chips, etc.) and its particle size and processing specification, the resulting powdered biomass will yield various levels of power output. Two major reasons for this are as follows.

Powder density: As shown in FIG. 3A, powdered wood biomass becomes explosible at a particle size in the neighborhood of 200 microns. Explosibility increases down to a particle size in the region of 50-60 microns, where further particle size reduction does not improve explosible energy release rate. So, to a point, smaller particles release more energy more quickly. Some energy conversion applications do not require as fast an energy release. Therefore, up to a limit (the 200+/−edge of explosibility), larger particles may be used. The main advantage of larger explosible particle distributions is they cost less energy to produce by forms of “grinding.” (See FIG. 3B, curve 33).

Biomass Material: Different biomass and other combustible materials yield different amounts of energy per pound. For example, at a given particle size, hardwood powder will release more energy than softwood per pound. Corn stalks may be slightly less. Each material has a certain calorific value when it comes to energy conversion. Also, hardwood tends to reduce more easily than more friable fibrous corn stalks. They both have differing internal structures as seen on a microscopic level. For a given grinding (particle size reduction) process, particles of hardwood may tend to be more uniform in nature, whereas corn stalks more elongated and torn strands of fine diameter particles. These morphological differences also affect the fuel quality and energy release rate during conversion. And lastly, the total surface area exposed for a given diameter of particle varies with biomass type, as it is related to the microscopic structure of the source.

Fuel Use: The end use of the powdered biomass is the number one consideration in choosing the “grade” of fuel required for that application. For example, when using powdered biomass to heat a home furnace, particle reduction cost could be reduced by using a lower grade of powdered biomass. This “lower grade” of fuel would consist of larger particle size, require less grinding cost, and may come from a less expensive biomass source (corn stalks, grass, softwood instead of hard woods). FIG. 3C gives examples of three different explosible particle size distributions.

Conversely, when choosing a fuel grade for use where more power is required, particles that combust at higher rates per particle would be used. This would translate to hardwoods with smaller particle sizes and higher reduction costs.

Ash: Remains of minerals and other trace materials after complete combustion is called ash. This substance varies with type of biomass from about ½% for hardwood, to 2-6% or more by weight or more for grasses and corn stalks, with Miscanthus being on the low end and Reed Canary grass on the high end near 8.5%. Percent ash (% Ash) is a significant fuel quality variable and will vary with fuel grade specification based on ash tolerance at the end-use. Ash causes a variety of problems including cleanup and disposal, heated product contamination, particulate presence in post combustion exhaust or flue gas with resulting air quality regulatory issues, and corrosion of metal parts in various stoves and furnaces.

In some embodiments, the powdered fuel can contain cellulose and/or lignin. For example, the powdered fuel may include greater than approximately 10% cellulose, e.g. 20% to 50%. Powdered fuels with high lignin content, in certain embodiments, will ignite faster than powdered fuels with low lignin content, but may require more oxygen for combustion. In particular embodiments, the powdered fuel contains a low amount of ash by weight, for example less than approximately 10% to about 0.30%. The percentage of volatile mass may be reduced through drying of the powdered fuel. Additionally or alternatively, powder drying may be accomplished through the use of ultrasound (ultrasonic) frequencies.

Availability: One of the key factors that fuel grade composition depends upon is availability of biomass materials. Biomass materials can be shipped virtually anywhere. However, it is preferable to utilize near where it is harvested. Each geographical area will have their particular “specialty” of biomass feedstock materials available to blend into various grades depending on power output desired.

Fuel Particle Size Distributions. Methods, steps, and integrated processing systems to manufacture a range of powdered fuels are disclosed in the present application.

The lowest grade of powdered fuel is a powder including a material containing particles having a particle size distribution median and other statistical characteristics such that less than about 5% of the particles by weight have a size larger than an explosibility size limit for the material. The particle size distribution median and other statistical characteristics are selected for manufacture based on the use of the powder as a substantially explosible fuel.

In one embodiment, the material is biomass. In other embodiments, the material is a metal material, a metal alloy, a metal oxide, a plastic material, coal, or a hydrocarbon-bearing solid. In yet another embodiment, combustion enhancing additives are blended in manufacturing.

In one embodiment, the specification for manufacture for powdered fuel requires a method that includes a powder having a particle size distribution where less than about 5% of the particles by weight have a size larger than or equal to 200 mesh, at least about 25% of the particles by weight have a size smaller than 325 mesh, with the particle size distribution selected based on the use of the powder as an explosible fuel.

In another embodiment, at least 50% of the particles by weight have a size smaller than 325 mesh and at least 15% of the particles by weight have a size smaller than 400 mesh. This is referred to herein as a high energy, very explosible fuel.

In yet another embodiment, 5% of the particles of the explosible powder by weight have a size larger than or equal to 80 mesh and at least about 15% of the particles of the explosible powder by weight have a size smaller than 200 mesh, with the particle size distribution median and other statistical characteristics selected based on use of the powder as a substantially explosible fuel. This fuel will be easier to manufacture and supply large volume heating applications. In a further and more explosible embodiment than heating fuel, 5% of the particles of the explosible powder by weight have a size larger than or equal to 200 mesh, and another reduced the threshold down to 1%.

Methods to manufacture very high energy fuels become more challenging and require more energy for size reduction as in this embodiment which calls for 50% or the particles of the explosible powder by weight have a size smaller than 325 mesh and at least 15% of the particles of the explosible powder by weight have a size smaller than 400 mesh. Further increasing the explosibility toward the lower particle size limit according a further embodiment of the present invention involves producing a fuel with at least 70% of the particles of the explosible powder by weight having a size smaller than 325 mesh. Yet another embodiment calls for 30% of the particles of the explosible powder by weight having a size smaller than 400 mesh.

To produce a mid-grade, at least 30% of the particles of the explosible powder by weight have a size smaller than 200 mesh, with another specified as at least 30% of the particles of the explosible powder by weight having a size smaller than 325 mesh. An additional embodiment further tightens the particle size distribution specification, resulting in a method to produce at least 40% of the particles of the explosible powder by weight with a size smaller than 200 mesh.

In the last embodiment, systems using just methods of Hammermill steps 1 and 2 without the energy intensive very fine grinding step 3 will be able to produce a powder with less than 1% of the particles of the explosible powder by weight having a size larger than or equal to 80 mesh.

Fuel Blending: Since the types of biomass crop are directly dependent on weather conditions, geographical location, altitude, etc., multiple sources of biomass all within the same region, with varying seasonal availability. An example would be upstate New York where everything from corn to hard wood to soft wood and wheat is harvested. Each of these is a biomass source and can be reduced to an explosible powder. As discussed previously, they each have different power availability (calorific and explosibility rate). These differing materials will each be given a BTU/pound or similar calorific output rating and blended on a weight basis, before, during, or after the grinding process to achieve the desired energy output and combustion rate specified.

Different blending ratios can be used for different fuel grades as follows: lower grades for home heating and general use and higher grades with lower ash for automotive and other applications where high heat generation is most advantageous. These grades will be sold at different prices depending on the costs of feedstock material and the work required for the particle size grade composition.

Additives: The addition of certain explosible and combustible but non-explosible materials can enhance biomass combustion, alter flue gas chemistry, or airborne particulate. Specifically, pines and spruces have a sap in the wood lignin that binds a lot of “dirt” from coal during burning. The result is collectable and disposable thick black oil that washes out the sulfur and heavy metals for example, binding substances that would otherwise end up as exhaust gas air pollution. Also, hardwood has a higher energy content and a higher density that helps improve the softwood combustion and handling. The Scandinavian use of softwood with coal for flue gas improvement is one such example. Spray on liquids can also be applied, and a solution emulating the Scandinavian softwood co-firing “treatment” of coal used in a Specialty Fuel is one option. Some metals, chemicals, and compounds can be made explosible simply by grinding. Others are combustible and do not interfere with powder combustion. The additive processing process varies with material and is, therefore, not shown beyond its entrance point in receiving 520 in FIG. 5, entrance into optional storage 638, pre-reduction blending and additives and the final blending operation 820 in FIG. 8. The additive processing stream is relatively straightforward. Dry material additives enter receiving 500-502, enter the data entry and payment system 502, are unloaded 506 and sent to their own temporary storage 508. Processing dry materials involves future feeding, particle size classification, optionally 1 or 2 steps of size reduction, sizing, ending with optional storage for addition on demand at 638 or final product blending 824. A liquid additive undergoes the same receiving and storage functions as does a dry additive. In use, it will require pumping, mixing, perhaps dilution and heating; application will be at blending points in the main process such as at 638 or 824. The EPPM is a unique system to produce various types and grades of an entire new line of explosible powder fuels controlled to specification. The special blending function, whether early or late in the process, is another inventive feature, enabling still further applications of the core explosible powder technology.

In general, an additive stream for the EPPM system improves the combustion, the completeness, the energy release, or flue gas composition and VOC content of substantially explosible powdered fuels and its combustion byproducts.

An additive powder may be for example a material selected from but not limited to the following: boron, calcium, phosphorus, magnesium, silicon, sulfur, aluminum, iron, titanium, tantalum, zirconium, zine, and compounds and alloys thereof, bronze, titanium dioxide, coal, ultra clean coal, metal, plastic, sulfur dust, phosphorus dust, polyester dust, a hydrocarbon-bearing solid, polypropylene, polystyrene, acrylonitrile butadiene styrene, polyethylene terephthalate, polyester, polyamides, polyurethanes, polycarbonate, polyvinylidene chloride, polyethylene, polymethyl methacrylate, polytetrafluoroethylene, polyetheretherketone, polyetherimide, phenolics, urea-formaldehyde, melamine formaldehyde, and polylactic acid. Some may be used at 100% for a fuel.

The use of ultra clean coal, with substantially improved flue gas VOC's, may finally find a market niche when combined with burners designed and developed to combust explosible powdered biomass fuel. This material can be pulverized in the additive stream of an EPPM and mixed with varying amounts of powdered biomass ranging from a low of 10% or less to 90% or more. Given its flue gas attributes, it may be used as an additive in pellet manufacturing as well. Regular varieties of coal and ultra clean coal are discussed in several areas of this disclosure.

### The Explosible Powder Production Module (EPPM)

A complete production system machine, the EPPM, is formed with an internal network comprised of a unique combination of input/output paths, internal flow paths to and from various intermediate particle manipulation steps and sub-combinations thereof, all to accommodate a wide range of raw material types and conditions, in harmony with dynamically changing fuel grade production output requirements, while controlled to consistently meet explosible powder fuel specification requirements.

It is important to view the integrated whole of numerous equipment subsystems located inside the plant support facility as a machine, a complete processing system, a production module comprised of a unique combination of subsystems controlled and operated by numerous optimal methods and internal machine control means, all critical to perform specific functions, processing feedstock into a range of powdered fuel products to specification. Its goal is to produce a product range that has never been manufactured before at high volume throughput with affordable energy input, all to a rigorous quality specification for the direct production of energy. This EPPM is a system, a flexible complex apparatus, and the critical conversion apparatus in the middle of the Farm To Flame (F2F) stream,

### Process Control Mantras

Below are process methods, steps, and apparatus control techniques to establish, maintain, and control the EPPM, driven by imbedded strategies for energy yield optimization in terms of BTU/lb, while minimizing production energy/lb and to maximize $/lb sales cash flow and resulting investment return. The disclosed manufacturing system and optional/alternative hardware input configurations are interconnected to enable this first-of-a-kind assemblage, to produce a new family of explosible powder based alternative fuels and grades, based on a unique global system control strategy, responsive to a range of perturbations in both the feedstock supply side and energy conversion end-use demand.

To further define, the EPPM is an integrated apparatus comprised of specially selected, connected, configured and controlled components. This apparatus is a complete system constructed and configured for optimal control to produce the desired end powder fuel product. Small EPPM versions may be mobile, truck mounted devices, which can visit raw biomass sources and produce final product. Farmers could take advantage of this service, or choose to hire the nearest local EPPM to process fuel for their own consumption or for market entry.

### Range of EPPM Control

It should be understood that the principles, methods and techniques disclosed herein for the Explosible Powder Production Module (EPPM), may be delivered through a range of measurements and control actions to accomplish the desired functions, from the simplest, manual types all the way up to total internally automated integrated and intelligent control of the EPPM machine apparatus. The degree of automatic control in no way should preclude the applicability of any one or more methods, even if the means may be different. Specifically, the control means within the EPPM may range from highly manual with appropriate measurements, all the way up to the use of automatic components to accomplish the same function. This disclosure covers the range of means and methods with the spirit of equivalence in mind.

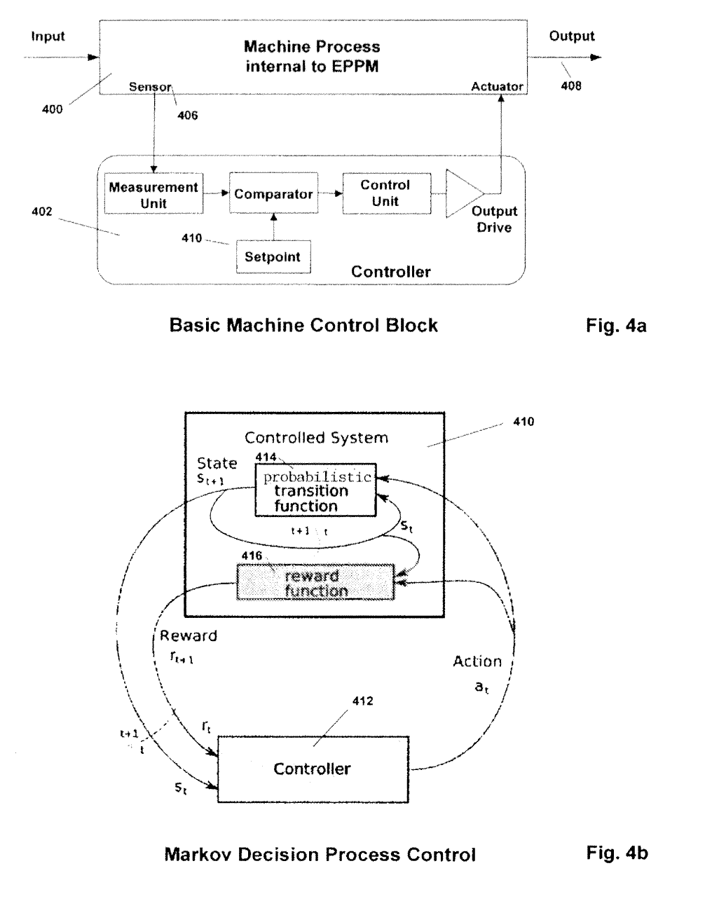

FIG. 4A depicts a control block for a basic controller and its integral nature with the mechanism it monitors and controls. This basic block is present in many forms throughout the EPPM, from simple to sophisticated and from low level subsystem to high level EPPM control. In fact, the very top loops monitor final particle size and %moisture for the current grade and raw material in production. It is these very control loops that stitch the tiniest sub-operations into the whole to form an EPPM. The EPPM itself is actually controlled by a combination of such basic control loops in more advanced forms, PID and DDC, for example, and more are listed below. The point is that the integrated control structure clearly interconnects and stitches all of the various EPPM sub-systems into one functioning entity, an apparatus for the production of an explosible powder fuel.

Top level control found in the EPPM and in the intelligence that interconnects nearby EPPMs into a larger entity may take advantage of even more advanced types of self-learning and organizing intelligence such as neural networks or a probabilistic Markov Decision process graphically depicted in FIG. 4B, with less sophisticated control and decision making diagrammatically depicted in FIG. 4A using algorithms from the simple to the advanced. The point is that it's the integration of such intelligent control schemes within the EPPM with the custom designed and interconnected components that enable this unit to perform its function, reducing raw feedstock to explosible powder within specification.

The training of EPPM control loops, commonly called tuning, to function in a stable and desired manner is accomplished using advanced control components commonly available from commercial suppliers in the industry, and will become integral parts of the EPPM itself. Specific tuning methods to perform intelligent analog and direct digital control within the EPPM can be similar to those disclosed in U.S. Pat. No. 6,546,295 to Pytsi et al., which is hereby incorporated by reference in its entirety.

### EPPM Internal Blocks—Farm to Flame System

One aspect of the present invention relates to a method of preparing an explosible powder suitable for combustion in an oxidizing gas. This method involves providing a biomass feedstock material and drying the biomass feedstock material to a moisture level of less than or equal to 10%. The dried biomass feedstock material is milled to form an explosible powder suitable for combustion when dispersed in an oxidizing gas.

Another aspect of the present invention relates to a system for preparing an explosible powder suitable for combustion when dispersed in an oxidizing gas. This system includes a drier for drying a biomass feedstock material to a moisture level of less than 10% and one or more mills for milling the dried biomass feedstock material to form an explosive powder of a particulate size suitable for substantially complete combustion in an oxidizing gas.

Receiving 500 is the beginning of the EPPM & PPPM Overall Block Diagram of FIG. 5. This is the entry point to the EPPM/PPPM for various raw material forms of farm, wood based, and recycled wood products biomass plus other sources such as biochar, explosible powder, and liquid additives plus various coal types. These feedstock sources are shown diagrammatically in FIG. 2 and receiving and initial preprocessing blocks for selected ones here in FIG. 5, with the operational processing and control strategies of each block disclosed and discussed as follows.

While much of the receiving operation is the same for all types of biomass, there are several variations as well. For example, raw biomass material from the farm and agricultural residues 204 is logged in 502 by a product type identification (ID) and the supplier. Along with the above information, % moisture may be determined by an electronic probe and entered into the receiving database entry along with weight. Decisions about the need and timing for preprocessing or drying are made by the receiving system. After unloading 504, by an unloading method that is raw material and delivery truck dependent 506, the material may either be processed immediately for initial particle size reduction and drying to the EPPM input specification 510-538, sent to a temporary storage location 508 to await processing, or run completely through the EPPM/PPPM beyond 534-538 directly. Once the load has been logged in 502 and attributes entered, load tracking begins and payment is initiated in the accounting subsystem.

The receiving subsystem of the EPPM, as shown in FIG. 5, works similarly for various types of wood based biomass, which will primarily be received as wet chips and sawdust at 510. Again decisions about the need and timing for use and drying are made by the receiving system, with choices of sub-system, the method and mode of next step handling, preprocessing, and possible immediate processing through the EPPM/PPPM or storage. Dry forms of the same biomass, not including construction and demolition debris/recycling will command a slightly higher price and may go to incoming storage or directly into the EPPM particle reduction sub-system.

Whole log receiving 514 is an EPPM/PPPM option based on regional supply and economics. The receiving steps are essentially the same, with % moisture determined by standards for green cut logs, probes, or other types of sensors. Measurement of log diameter and length is an option to include with load weight and raw material type composition. Logs within receiving input size specification are debarked if necessary, then processed through an optional chipper then available for entry into the EPPM for drying, with intermediate storage options at every step. The price paid for whole logs will be less than that for the same chipped and possibly debarked equivalent.

Receiving recycled wood products, as shown in FIG. 5, in an unchipped form is another input option for the EPPM. A crusher or similar device such as a grinder/shredder from Crosswood Recycling Systems, is part of preprocessing, and will be required to break up the wide range of pallets and other demolition material. Nails and other metals and foreign material are removed in successive reduction steps, beginning after the crusher and optional coarse chipper, and the first and possibly second hammer mill. Metal and other foreign material detection and removal may be installed between each step as needed, and is a must before the reduced product stream enters any high speed impact or other fine grinding mill.

An optional storage sub-system, as shown in FIG. 5, for each type of biomass and other material source creates a buffer with surge capacity to balance raw material flow between the basic receiving operation and the preprocessing section to follow.

Turning to FIG. 5, preprocessing 510 of the incoming biomass and other sources is the general raw material entry point. It provides to the receiving operation the necessary flexibility to insure each type of raw material meets an acceptable milling entry input specification, based on the type of feed stock, % moisture, incoming particle size (from round bales, pallets, or logs to chopped biomass, wet or dry chips, grasses, and sawdust), and the chance of foreign material.

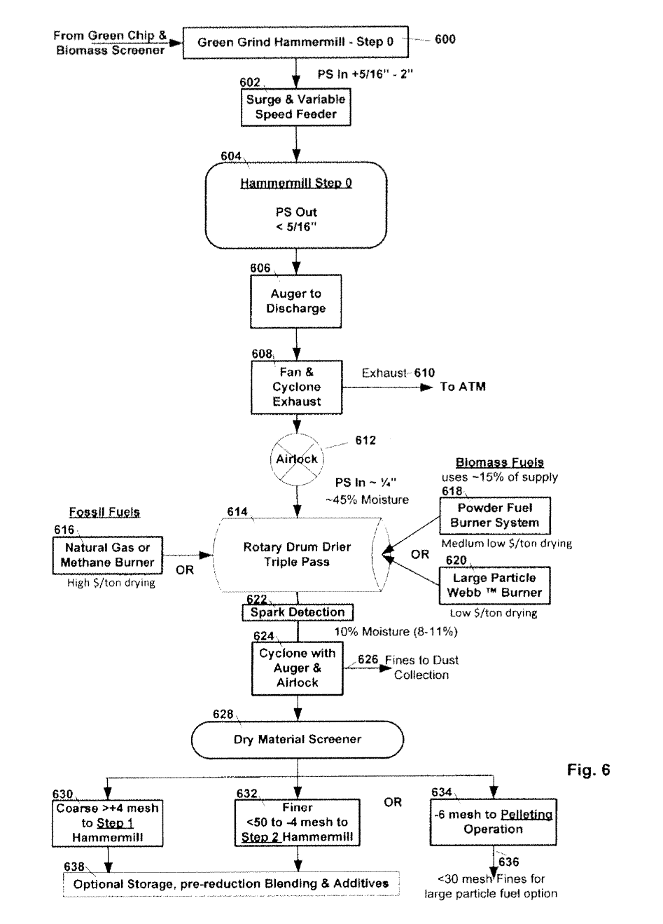

De-balers 512, crushers 518, lumpbreakers, grinder/shredders 516 and 522, possibly chain mills, and even a coarse hammermill 600-612 of FIG. 6 all can perform the reduction operations necessary to meet the milling input specification for the wide range of input sources. It may be advantageous to use check screening 532 up front to separate out small foreign material such as cigarette butts (listed but not shown) and other larger foreign material 523-532, or the system will bog down. The addition of horizontal swirl on large round sieves increases residence time and fractionation, with the addition of up to four (4) decks possible with hardware from Russell Finex for example. Gyratory screeners such as a dual deck configuration from BM&M work well as do units from Great Western Manufacturing.

Slow moving crushers 518 offer great utility in the receiving and preprocessing areas of the EPPM, having high capacity since their interfering finger design produces high shear, tolerates nails and bolts, and consumes very little energy.

The goal of the Preprocessing Biomass for General Raw Material Entry section 510-522 is to reduce the wide range of particle sizes of incoming feedstock (large wood chips, 2×4's, 8″ corn stalks, whole logs, etc.) to the manageable size of 2 inches or less, so that further particle size reduction to the EPPM/PPPM Input Specification for Drying 524-523 of approximately ¼ inch+/− can be reached. Material entering this sub-system, ranging in particle size from 5/16″-2″ is metered through an input auger 526 then fed onto a conveyor belt for transport to size classification 523. A cross belt magnet removes tramp metal from the flow 530 to protect downstream equipment and reduce the chance of sparks. A non-contact NIR % moisture measuring sensor generates an extremely valuable continuous data stream used as a part of global module mass flow control and raw material tracking

The green chip & biomass screener 532, equipped with a 2″ punch plate screen 534 scalps larger particles to 2″ in size, sending material >2″ to trash (mostly rocks), A 5/16″ woven wire screen 536 passes material from 5/16″ to 2″ to the Green Hammermill Step 0 for further size reduction. Smaller particles 538 of (and under) minus 5/16″ fall through and are either discharged directly to drying, or direct to the Dry Step 1 Hammermill if pre-dried biomass like lumber chips is the source.

For the mid-range of particles from screener 532, the use of a “hog” or coarse hammermill 604, described later as Step 0 in FIG. 6 as a front end major raw biomass initial breakdown device in the EPPM/PPPM is a good choice when considering options to accommodate a wide range of challenging input feedstock or respond to certain regional supply specifics. For example, hogs are often used to produce a wide range of particle size reduction for scrap generated in the lumber and pulp and paper industries.

Biomass enters the Green Grind Hammermill Step 0 sub-system 600 to be reduced from an incoming mill acceptance particle size range of + 5/16″-2″ down to the drier input specification of a nominal ¼″ (< 5/16″ minus). A Surge Hopper and Variable Speed Feeder 602 delivers raw material to the 604 coarse Hammermill Step 0, at a rate dictated by hammermill motor current. For each of reduction Steps 0-3 in the EPPM, a static magnet is located at the mill entrance to capture any ferrous material that can damage the following high speed rotors and potentially cause sparks. This initial reduction, called Step 0, reduces the biomass to < 5/16″ for drying. A discharge auger 606 feeds an air relief system for dust collection 608 comprised of a fan, cyclone for returning fines back to the Hammermill Step 0 discharge auger, an exhaust 610 and a heavy duty airlock 612. Kice Industries offers a range of air filtration systems from cyclones to baghouses. Up to this point, all biomass raw material is handled with “kid gloves” to insure minimum generation of fines, which would otherwise be carried into the drier of the next step and subsequently add to air quality particulate, a major regulatory challenge for drier exhaust.

A drying step 614, as shown in FIG. 6, may be utilized at this point to reduce % moisture to specification of approximately 10% a with nominal 3% swing. It should be noted that further drying can also be accomplished downstream in association with any of the particle reduction steps to improve material processing characteristics. Raw material dryness is important for downstream sub-processes and is a major front end control variable. The difference between incoming material in the 8-10-12% moisture range, let alone green values in the 30->45% range, and a low 8% moisture could offer a “huge reduction in horsepower” energy requirements. This occurs since moister biomass is more resilient and requires increased horsepower achieve a certain particle size reduction.

A rotary triple pass drier sub-system 614 of EPPM/PPPM system, where heat for feedstock material moisture control is produced by a furnace, uses one or more burners 614 suitable for the direct combustion and energy conversion of substantially explosible powdered fuels. These powder burners are fed by fuel produced in the EPPM and supported by the required process and control system, to include a heat exchanger thermally coupled to the exhaust end of the burner. In order to meet local particle emission standards, a required flue gas particulate reduction equipment will likely use electrostatic precipitator technology, including necessary ash recovery and storage, and a heating fluid circulation system thermally coupled to the heat exchanger. Use of our powder fuel combustion technology is likely the most cost effective overall and is an unexpected advancement in the state-of-the-art for all types of drying, particularly rotary biomass driers. While the fuel cost for powder burners is slightly more than Large Particle Webb™ Burners 620 using fuel 31 in FIG. 3A, the space requirements for explosible powder burners using fuel 30 are substantially less as is the capital equipment costs compared to these very large and expensive sub-systems supplied by Onix Corporation and others. Fossil Fuels 616 may also be used to fire natural gas or methane burners, but at a high cost per ton.

Spark detection 622 is used for immediate shutdown of an drier air system and instant combustion shut-off in the case of explosible powder burner heating, an event which is much slower with large particle 620 burners. The drier keeps rotating to smother any fire and prevent local heating and warpage.

A cyclone with an auger and airlock 624 performs fines collection 626, while passing the nominal 10% moisture biomass on to the dry material screener 628 infeed section conveyor via a dry material inclined conveyor or other means (not shown).

The process flow is then fed to the dry material screener 628 for sorting and classification by particle size. A two deck screener uses for example a 4 or 6 mesh woven wire screen and a 30 mesh fines screen for large particle drier heating 636. The coarsest material of >+4 mesh is sent 630 to the Step 1 Hammermill, while finer material in the range of <50 to -4 or -6 mesh is preferably sent to Step 2 Hammermill, or the −6 mesh may be sent directly to the integrated pelleting operation raw material infeed 900 in FIG. 9. Exact cut mesh screen selection is a choice of operations given the balance between pellets and powder in demand.

Next comes an optional storage sub-system 638, as shown at the bottom of FIG. 6, which offers buffer surge capacity. Input raw material reaching this point is ready for particle size reduction. Having storage capacity by raw material feedstock type or particle size distribution creates the opportunity for blending at the input stream level prior to successive Steps 1 and 2 major particle size reduction sub-systems, where complete mixing will occur for two or more input streams. Some additives, including liquids and larger particulate dry material, are best added to and integrated with the dried pre-ground feedstock. One embodiment advantageously introduces additives with mixing at this approximate point 638 in the process.

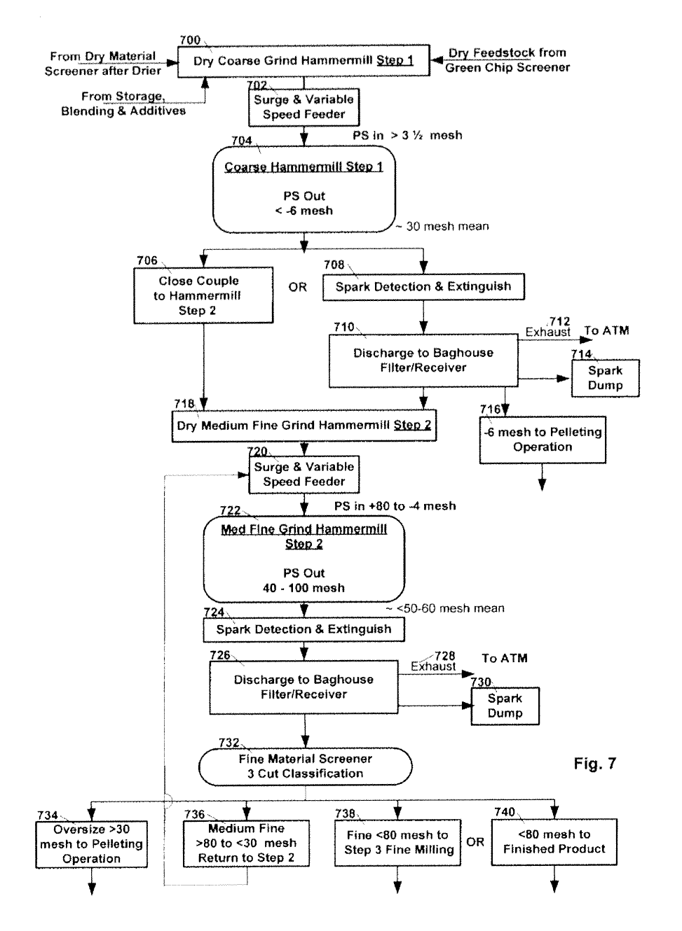

Dry Coarse Grind Impact Hammermill—Step 1 size reduction 700 is shown at the top of FIG. 7. Its purpose in one embodiment is to grind incoming material of particle size >3½ mesh, reducing it to 6 mesh minus (< or under 6 mesh) with a particle size distribution mean near 30 mesh. Material is fed into the hammermill by a surge hopper and variable speed feeder 702 system. As reduction occurs inside 704, product continues to be recycled and reduced in the mill until it reaches the correct size and exits, flowing through one of several styles of fixed perforated screens.

Hammermills are efficient and forgiving workhorses of the coarse particle size reduction sub-system. They may be located in series, parallel or both to accommodate the throughput volume flow requirements, gracefully handling foreign material with little or no damage. For coarse and even medium fine particle reduction, companies such as Pulva, Buffalo Hammer Mill, Bliss Industries, Classifier Milling Systems, and Praeter Sterling offer a variety of capable hammer mills and other particle reduction sub-systems. The Bliss TFA Eliminator is a preferred choice of many good options.

Up to a certain point, some fine particle reduction grinding can be accomplished using hammermills (grinding jaws with screen control) as an “impact grinder” to add shearing force against the jaws for high axial fibers. Low pressure air systems may be needed to move particles. Fine grinding of corn stalks is not a low energy product to produce. Reduction of biomass sources such as corn stalks and grasses is one of the most difficult, as the material is springy and is of high strength longitudinal macro and micro structure. There is a minimum of data and experience available from the industry experts at particle reduction equipment manufacturers for reducing this type of biomass at high volumes.

Particle size reduction for powdered fuel generally takes 2 steps to achieve desired particle size requirements at any significant throughput. Specifically, after the initial Step 1 particle size reduction from the mill input specs, a second finer Step 2 reduction step followed by a high speed attrition grinding mill with adjustable threshold classifier 800-816 is a preferred embodiment depicted in FIG. 8 and discussed later. More steps may be added: one on the front end, to reduce received biomass to input specification requirements, and another in series with the two reduction steps to insure adequate mass flow throughput. Tradeoffs exist between the degree or amount of reduction per sub-system, component, electrical energy required per pound, and overall throughput capability.

Explosion protection is an extremely important issue in powder production, both in spark detection and mitigation. Many designs are labeled PSR for pressure shock resistant, meaning they will not deform or split in the event of a dust explosion. Mills, screw conveyors, and the like may be designed up to 145 bar and called pressure safe, since they can contain an explosion at such levels. Piping designs meeting ANSI standards for 150 psi are no problem. Many devices and sub-systems carry an ATEX rating. It is the European Union's explosive safety protocol, which most countries have adopted. ATEX ratings do add cost to the various hardware devices and sub-systems available. Blowout panels as well as flame and explosion detection hardware devices are used through the design.

The exit of Step 1 Hammermill may be close coupled 706 to Step 2, or pass through a spark detection and extinguishing sub-system 708 and then discharged into the baghouse filter/receiver 710 which will pass the wet extinguished material directly to a spark dump 714, or under normal circumstances, to either the Step 2 Hammermill 718 or send the 6 mesh minus product to the integrated pelleting operation beginning at 900 in FIG. 9.

A Pellet Manufacturing Operation, as shown in FIG. 9, is useful in combination with an explosible powder EPPM, becoming a PPPM for several reasons. First, manufacturing and sales of pellets will bring immediate cash flow to a new biomass energy fuel facility, while the demand for substantially explosible powdered fuel ramps up. Second, both acceptable and oversized raw material may flow between the operations, improving efficiency and reducing the cost per pound of both fuels produced. Third, the seasonal nature of fuel sales and supply chain length allows for seasonal product balancing, where pellets are made during lower powder demand cycles and moved into storage or early shipment.

With the integrated powder and pelleting operation, energy can be saved by sending stubborn oversize particles to the pellet operation to become fuel directly, rather than investing further in this costly reduction. Particles larger than 30 mesh 734 are separated first and sent to the pellet operation. Likewise, fines removed from pellet processing will be collected as fuel either for near term biomass large particle burner drying needs or stored or directly blended in the powder stream. With this unique integrated PPPM design, there is no raw material waste or the need to waste energy beating on difficult particles.

For material conveying, simple mechanical conveying for short runs is used when possible. Runs greater than 50 feet may employ pneumatic conveying from companies such as Premier Pneumatics.

Dealing with dust collection, aka filtering, is an operation in each of FIGS. 6-9. Every particle reduction operation or transfer of raw material from one sub-process to another will produce some “dust,” so the use of dust capture and feed to dust collectors or baghouses is needed. Dust collector outputs discharge through rotary valves and the fine powder product is then transported to storage silos via pneumatic conveying, while larger particles are returned to the process. Dynamic Air Systems and Kice Industries are good examples of a number of companies that offer dust collection sub-systems. Use of a baghouse filter/receiver is required after every dry particle reduction step in the process of the present invention, unless the mills are close-coupled as is possible between Steps 1 and 2 of FIG. 7.

Dry Medium Fine Grind Impact Hammermill—Step 2 (718), as shown in FIG. 7, is needed for making powder, not just pellets, and utilizes similar basic hardware components as Step 1 with a more aggressive, liner grind. This second mill 722, takes the particle size down to the explosible range for a substantial portion of the remaining stream, while sustaining mass flow throughput. A surge hopper with a variable frequency drive for the auger feed 720 feeds a particle size in the range of 4 mesh minus down to +80 mesh into the medium fine grind hammermill 722, preferably manufactured by Bliss Industries. In one design embodiment, the anticipated amounts for example of accepted output particle sizes from this Step 2 meeting explosibility criteria are: 50-60% pass through 80 mesh; 30-40% through 100 mesh; 8-10% through 150 mesh; and fines at 5% would pass through 200 mesh. The output is fed past spark detection and mitigation equipment 724, to a baghouse filter/receiver 726, then to high capacity screening. Atmospheric exhaust 728 and a spark dump 730 are part of the Step 2 reduction system as well.

Screening and sifting provides a method for mechanical particle size separation and classification in a flowing stream by virtue of the opening size of various types of mesh media. Inside the EPPM, the raw material mass flow rate on screens should be controlled to insure consistency across the screen surface. These screens utilize significant near horizontal called side-to-side movement with minimum near vertical, called up and down action, to sift the material output after reduction Steps 0 and drying at 628 in FIGS. 6 and 732 at the bottom of FIG. 7. Many biomass particles have high aspect ratios (length-to-width), even though their “diameters” may be in the desired range. With typical sieving operations, many of these over-length particles “stand up” and undesirably pass through some screens.

Use of large area, single or multi-deck screeners, such as the “Super Screen” manufactured by BM&M, with their aggressive horizontal gyratory screen action offer greater throughput capacity and efficiency, while drastically reducing the acceptance of long particles common with traditional screeners and sifters. Screens provide for classification and removal of product meeting the particle size specification and for separation and return of any particles still needing further reduction.

Screens are finicky, undergoing heating and abrasion that reduces life. Sweco is a major manufacturer of screens for sifting and sizing, and devices from BM&M Screening Solutions in Canada work well for wood chips and other high aspect ratio biomass of the proper diameter, which contaminate acceptable product and produce “rocket particles” during combustion. Powders transported on a near horizontal screen often exhibit a phenomenon known as “sideshift” where the flow is not uniform across the screen. Sideshift is much like what happens with a carpet piece laid atop an installed carpet. In a preferred embodiment, gyratory sifters are used for mechanical classification. These devices vibrate with little or no vertical component, thereby not standing high aspect ratio particles on their ends to aide with large particle separation. Gyratory screen use is a preferred embodiment because of the finished product quality improvement they offer. Also useful are sifters from Great Western Manufacturing of Leavenworth, KS with multi-deck units where particle bed depth can be controlled.

Ultrasonic devices comprised of amplifiers, drivers, and transducers provide another, highly controllable and energetic source of energy to operate screens and to clear them from “blinding” or plugging, common with higher mesh varieties. Use of these devices reduces maintenance downtime and improves powder sifting throughput for high mesh count screens. Modulation of the drive signal frequencies and amplitudes using the MMM Technology, offered by MP Interconsulting of Neuchatel, Le Locle, Switzerland, enhances the sifting characteristics of screens, including agglomerate breakup to improve product handling and uniformity in many ways including blending. Telsonic Ultrasonics, also of Switzerland, is another OEM supplier in the bulk powder industry. Special accommodations to maintain screen life are necessary to utilize ultrasound driving technology.

Another design goal of the EPPM in this disclosure is to classify raw material particle size mechanically rather than with air wherever possible. At each stage of particle size reduction, the mill output may be dumped onto a screener to perform sifting and separation 732, in lieu of more energy intensive air classification except when necessary to meet tight specifications as in Step 3 in FIG. 8.

The output from the Step 2 reduction filter/receiver is fed to a three cut, two screen multi-deck screener and sifted for classification. Oversize product >30 mesh 734 is sent to the Pelleting Operation, with Medium Fine particles 736 from 30 mesh minus to +80 mesh (<30 to >80 mesh) being returned to the auger infeed of Step 2 for resizing. Explosible product passing through an 80 mesh screen (<80 or 80 mesh minus) may be discharged with appropriate dust collection directly to finished product 818 in FIGS. 8 or on to 800 Step 3 in FIG. 8 for further particle size reduction and use in higher grade fuels.

Air Swept Pulverizing Attrition Mill with Classification—Step 3, as shown in FIG. 8, is the beginning of what is generically termed in the industry as “fine grinding,” whereby the remainder of the particles, perhaps 10% by weight, are reduced toward their intended final particle size specification. If the particle size is to be in the neighborhood of 74 microns, 200 mesh, then the use of an ACM (Air Classification Mill) makes sense. The highest energy density fuel falls into this category, and larger particle size grades can take advantage of this classification technique too on the remaining portion of the main stream. Attrition milling is preferred over impact milling, both which are useful in accordance with the present invention. It is worth noting that there is no desire to reduce particles below about 50 microns, as there is no improvement in explosibility characteristics and generating particles of such small size is very energy intensive and rate limiting.

In one embodiment, air classification 816, which balances centrifugal forces with aerodynamic forces on the particles, can be used to dynamically select or change the “cut point” particle size threshold. By increasing the speed of rotation of the classifier drive, it removes ever smaller particles through the axially oriented “windows” created by the interfering “fingers” rotating at high speed. Decreasing the speed accepts larger particles.

High speed attrition grinding and moderate air flow will produce the desired fine grind which is discharged through the classifier, again into a bag house filter/receiver 810. Attrition grinding 804 at the right % moisture can shred these friable fibers. Pin mills and ball mills, while great for brittle product that shatters such as coal and are optionally used in a separate process flow stream, tend to be less efficient with raw biomass material. However, they may be utilized for a separate reduction stream for coal additives. Multi-stack rotor designs, such as a mill from Hosokawa or IPEC, perform well, acting like an attrition mill but better handling materials with cellulose and lignin.

The discharge of the Step 3 pulverizing operation is again fed through spark detection and extinguisher 806, then discharged to a baghouse filter/receiver 810 with an exhaust 812 and spark dump 814, and finally to 816 air classification. In an alternate embodiment, the air classification function may be integrated with the fine grinding mill 804.

In the configuration depicted in FIG. 8, the output particle size threshold of the air classifier 816 may be adjusted to meet current operation requirements. The accepted product 836 is fed most likely to high grade intermediate finished product (FP) storage 818b, while more stubborn oversize particles may exit 832 to low grade intermediate FP storage 818a.

The value of dust collection, the prior screening, and other types of dynamic particle size classification become more important as size reduction advances. These “fine grinding” steps, may not use “grinders” per se, but are increasingly energy intensive. What helps is that a significant portion of the feedstock has already been recovered in prior reduction and separation steps, so the total mass throughput is substantially reduced, in one case to about 10% of the original flow.

Powder to intermediate storage by biomass type is the next block on FIG. 8, signifying the end of the particle size reduction and basic fuel preparation sub-process. Fuel from selected biomass sources is stored in one of several silos 818a-818b in preparation for final blending or directly sent to blending 834. The number of silos will vary somewhat on a regional basis, as dictated by the variety of feedstocks available for processing, but primarily by the variety of powdered fuel grades chosen to be produced by a specific local EPPM based on grades in demand.

Blending to fuel specification 820 is an important downstream function of the EPPM shown in the lower portion of FIG. 8. Fuel is fed into this sub-system from either of the intermediate FP storage silos 818a-818b, or from a finished product silo if desired 822-822d. Additives 824 are a third class of potential input sources. The choices are either continuous or batch in nature. Batch mixing is easier to perform and to understand conceptually, as fixed amounts of the ingredients are loaded into a mixer or blender and then uniformly integrated. However, batch operations often use more energy. Another alternative for batch blending is supplied by Dynamic Air Systems, and accomplished within a vertical silo or bin by pulsing air into the bottom via a Mexican hat type plug. When complete, the “plug” lifts allowing product to flow out the bottom. If an application need or a business advantage becomes apparent that requires a narrow ranged particle size distribution within the overall explosible region, the EPPM can perform such particle size selection functions with a minimum of interconnection and configuration changes. Such a need for a particle size-range controlled fuel specifications would simply be an economics based business decision, one that could be implemented easily and quickly.

Dynamic Air Systems also offers mechanical paddle and other types of mixers, such as the Bella, a horizontal paddle mixer that keeps the material suspended as it moves through, encouraging more consistent mixing. Continuous blending sub-systems are smaller, more compact and use less energy than batch mixers.

A separate air relief system is useful for the entire finished product storage and blending system as well as fans and vents for individual silos to contain and reclaim dust.

High Energy Fuels are a distinct category where high fuel density (BTU/lb & BTU/ft³) is required. Both the highest energy biomass and other non-biomass sources are utilized to produce such specialty fuels for applications such as hot air balloons and high power 4 cycle engines, for example. Non-biomass fuel sources utilize similar, yet fewer, process steps for particle size reduction, and may be used to manufacture such custom fuels in an EPPM machine, using the planned additive stream. Mixing with finished product biomass fuel during final blending is an optional embodiment.

Final storage 822-822c or direct loading 830 are the last blocks on both FIG. 8 and the last sub-process within the EPPM which ends with product loading for entry into the distribution & sales portion of the supply chain 220-230 in FIG. 2. Typically the finished product departs blending 820 and enters finished product silos 822-822c containing the differing product types and grades. Loading for shipping usually is decoupled from blending, but it is possible and more economical to load 830 directly from the blending sub-system output. Database entry 828 and management of all finished product stock shipping information drives the loading and shipping operation.

Given the seasonal nature of various types of raw feedstock material supply, corn stalks and grasses for example, and the regional nature of seasonal energy demand, various EPPM's will adopt slightly differing bulk storage strategies driven by economic decisions within all portions of the supply chain surrounding the “EPPM System.” Low cost, extremely high volume storage devices are optional additions that are available for inclusion within each EPPM. Additional storage 822d may be installed within the EPPM or using an outsource model, is available from large and medium size affiliated operations on both the raw material supply side and downstream finished fuel distribution and sales side of the core EPPM. Agricultural produce including round bales of grasses and corn stalks, for example, are stored by the supplier and delivered on demand.

### Overall EPPM Internal Control Strategies

In summary, the tremendous and cost effective processing power of the EPPM disclosed above owes its capabilities to a highly function driven and unique combination of hardware, devices, and sub-systems, controlled by integrated control loops using optimal control theory and tuned with economics data, to achieve a small number of final fuel grades to specification, while flexibly accommodating a wide range of highly variable biomass and other feedstock inputs. As with any intelligent system, the EPPM is driven by a set of optimizing, nested, and interrelated control and decision making loops that make this machine a unique and highly responsive production apparatus.

To run the EPPM, applicants have developed a unique series of “metrics,” performance characteristics by which this totally integrated EPPM can be designed, governed, controlled, and operated. A number of these follow. It is understood that various combinations, permutations, derivatives, and amplifications of these parameters, metrics, and control strategies will become evident to one skilled in the art, and, within the spirit and intent of this disclosure, deemed equivalent.

Internal to the EPPM is an integrated system to optimize and maintain BTU/lb spec mean and statistical distribution target. The system design and operation is to minimize energy input (size reduction, air handling, dust collection, and drying) per pound and BTU-lb of powder output, while maximizing the tons per hour system throughput.

The EPPM will utilize waste heat first for drying, for example be located near/at power plants, industrial facilities, methane sources with “waste heat” whenever possible. The EPPM will use its own low grade explosible powder fuel as the next alternative, since using low cost energy to perform drying can drastically reduce the much higher price electrical HP requirements to reduce wetter particles. This is a major optimization control loop for intelligent tuning, with a very significant economic return.

Raw material can be optimized throughput in pounds per hour per type of input feedstock, by use of an intelligent tuning algorithm, which compares the cost of successively lower levels of drying and lessened drier throughput versus the increased throughput through the particle size reduction steps. Control of % moisture can be based on the data from this algorithm.

Throughput by increasing consistency (minimizing swings) on the front end raw material input for both particle size and % moisture can be optimized. For one embodiment, by controlling these parameters at the input and through maximum use of hammer mills, the net effect minimizes energy through the rest of the particle reduction steps.

Maximize lbs/dollar output yield per raw material source input type for a range of received % moisture and adjustment thereof. Minimize the cost*BTU/lb energy for drying to provide % moisture control through optimal control, flexible capacity, and front end receiving procedures. This value is computed and controls at every stage of particle size reduction in tandem with minimization of the resulting energy (grinding and air) cost per pound for reduction.

Final product blending optimizes and maintains specification targets such as, particle size distribution, BTU/lb fuel, and other specification metrics. A further input blending method on the raw material receiving end when particles are at the EPPM input size specification, will assist with this goal. Initial raw material blending and/or interstage blending at any stage (input, intermediate, or final) is an alternate embodiment to achieve the same final fuel specification targets.

Product mass flow rates are dictated by interstage efficiencies. Rates for given types of raw materials will vary and be controlled by the need to meet setpoints defined and dictated by the product specification and driven as a control offset by the current demand for fuel type.

With the control design disclosed to this point, any total throughput limiters will be easily identified by supervisory control and provide actual data to drive economic evaluation of the addition of additional equipment subsystems to the overall EPPM manufacturing apparatus based on the cost per fuel type and raw material process rates.

Controlled design options are disclosed to handle oversize particles still present at the normal final reduction stage. One such method may be the addition of an alternate lower volume grinder/reducer and/or accumulation or simple off-spec storage for resale to other biomass energy producers such as NE Wood Pellet near Utica, NY or as raw material for composite boards for example. This is the case for a standalone EPPM.

Another cooperative example might be to remove the “finest fines,” particles falling in the range of slightly under 1 micron to about 10 microns, to be utilized in chemical processes operated by others using various means to perform chemical extraction of cellulosic or other components. The manufacture of cellulosic ethanol, for example, could benefit from the high volume availability of such a raw material, and the cost of operation of a grinding system to only produce such an extremely fine powder could be extremely high.

### Process Measurements and Sensors for Data Acquisition and Control

The EPPM, thanks to its various internal devices, processes, services and sub-systems, exhibits a high degree of automation, closed loop control, and intelligence using and combining information. Integral to these unique capabilities are a number of sensors and automated measurement devices that need to be disclosed.

The system sensors include a temperature sensor, a mass flow sensor, a motion sensor, an acoustic sensor, an ultrasonic sensor, a powder presence sensor, a vacuum sensor, a pressure sensor, a position sensor, a powder feed speed sensor, a static charge sensor, a spark detection sensor, a flame detection sensor, an explosion detection sensor, an oxygen measurement sensor, a humidity sensor, a moisture sensor, a particle size sensor, a particle size distribution sensor, a particulate sensor, a weight sensor, a vibration sensor, a height sensor, a fill level sensor, a flue gas composition sensor, a raw material presence sensor, a material flow sensor, a raw material composition sensor, a fluid sensor, a refrigerant sensor, an NIR sensor, an IR sensor, an RF sensor, a metal detector, a foreign material detector, and any combination of these sensors. Many sensors will connect via wireless to the controllers.

Weight measurement sub-systems perform important data gathering functions from the receiving end to the output at the point for distribution. Systems using load cells and similar devices provide raw material incoming weight measurements for trucks, rail, and other units of feedstock delivered and received. Both manual and automatic weighing sub-systems are used to compute product pounds per unit volume. This data is generated at various process points and in the lab as well for quality measurement determination. Weight per unit volume is an important intermediate and final product parameter, so storage hoppers are equipped with sensors and indicators to measure both. For example, in hoppers or silos the use of a combination of weight load cells and height detection, likely acoustic or laser triangulation, enables the computation of volume & mass of specific type of fuel or fuel component.

% moisture is a key parameter measured and controlled throughout the EPPM. Data is provided by a number of sensing devices including insertion probes, contact sensors plus those based on IR and NIR (Near Infrared) non-contact technology. Data before and after drying operations may be acquired for local and global system control.

Incoming supply type identification benefits from the use of NIR data to identify and measure composition. % moisture can also be measured by these devices. Likewise, this same technology is used on-line and with various forms of finished product to insure compliance with specifications. Some locations have been shown on the EPPM/PPPM system block diagram,

The EPPM relies on the use of both on-line and off-line lab (or at-line) image processing techniques for automated particle size monitoring and measurement process control and material data generation in lieu of or in addition to traditional screen sieving sampling techniques to insure quality, specification adhering production of explosible powder distributions used as fuels. Locations of these devices are not shown on the process block diagram figures, as the choice of supplier and sample port design will dictate specific hardware.

As an alternative embodiment, the EPPM can use both on-line and off line lab (or at-line) batch and continuous laser imaging techniques for automated particle size monitoring and measurement process control and material data generation in lieu of or in addition to traditional screen sieving techniques to insure quality, specification adhering production of explosible powder distributions used as fuels. Likewise, particle size distributions and other statistical descriptors will control ultimate throughput as follows:

The throughput rate of raw material feedstock and subsequent reduction steps is maximized until it negatively effects the particle size distribution (PSD). If necessary, the throughput rate is reduced to insure the PSD stays within the current fuel type and grade specification.

For example, systems from Cilas Particle Size (CPS US, Inc) and Sympatec perform such a range of both laser and image based measurements and functions. Malvern Process Systems also offers in-line particle size analyzers, which they call “the proven answer to the optimization of grinding and classification processing.” A custom, low cost design for particle size with an on-line optical imaging port is currently in design.

The integrated pelleting operation is diagramed in FIG. 9. Its integration with the EPPM to create a PPPM that has great operational value, as previously discussed. The “finished” -6 mesh raw material arrives at 900 from three sources: the dry material screener 628 located downstream of the drier output product and air relief equipment 624; the Step 1 Hammermill sub-system discharge from the filter/receiver 716; and an oversize particle distribution >30 mesh from the Step 2 Screener classification 734. Material typically arrives via an enclosed screw conveyor.

A moisture balance system 902 raises the % moisture to 11.5% with additives, and sprayed on as a rate controlled by material flow. Then the ground wood or grass material is conveyed by pneumatic conveyor to the sized raw material storage silo 904 for a 6-8 hour residence time, where the % moisture of the ground material reaches equilibrium, surface moisture from the balance system becoming bound moisture. At the exit of the silo, an dry material bottom reclaimer unloader and metering auger outfeed 906 transfers the particles directly to the pellet mill infeed surge hopper 910, unless multiple pellet mills are in service, whereby a transfer conveyor 908 is employed. % moisture is again adjusted slightly with the addition of vegetable oil into the pellet mill conditioner as well as water. The product is fed to the pellet mill 912 by a variable speed metering auger 910.

The pellet mill 912 is a complete, free standing unit such as the Bliss Pioneer with two 250 HP drives, and able to produce 4-5 tons per hour. It includes a conditioner system for liquid additives. Completed pellets are discharged through a vacuum conveyor to a cyclone and airlock manufactured by Kice Industries. Product enters the pellet cooler 914 with 15 minutes retention time, which is fed by an air cooler system. The pellets are eventually discharged onto a 1″ scalp and sift pellet screener 916 to remove >1 inch overlength pellets to a tub. Fines are picked up and conveyed to a burner fuel bin or back into the powder process via the pellet dust collection system.

Accepted pellets enter the finished product pellet storage silo 922 via a bucket elevator conveyor, with its own dust control fan and filter system 920. Pellets exit the silo to supply the packing operation via bucket elevator with fines dust collection just prior to the packing surge hopper above the automatic bagger 924 with integral weigher. Finished pellets may also be discharged directly to shipping 930 for bulk pellet transport loading. Bags are stacked either manually or by a robotize palletizer 926 available from Fanuc Robotics, and then transferred and stretch wrapped 926 by an automated system in preparation for transport to the warehouse for storage and shipment 928. Loading for shipment 932 is processed through the order entry and shipment system 934 to include the weight, pallet count, shipper and order information, all entered into the proper order tracking sales database.

### Distribution & Sales of Powdered Biomass Fuel

The distribution and sales operations with four general types of customer arrangements are shown in FIG. 2.

The supply model to support distribution and sales is designed around a fault tolerant modular GPPM concept depicted in FIG. 1. Its key feature is that if one module should fail or become overloaded, other modules within the system are able to carry the additional load, much like a modern electricity grid or the Internet. Each module represents an EPPM or PPPM and a potentially co-located fuel depot (powdered biomass storage facility). From these locations, powdered biomass can be shipped in any direction at any time, wherever energy is required.

To completely understand the distribution model one must have a good understanding of the nature of the powdered biomass. Key features of powdered biomass are as follows: 1) safe to store (non-flammable until utilized in a burner); 2) safe to transport (no tanker or bio-hazard safeguards required); 3) no specialized transport medium required (covered dump trucks or covered railcars are fine); 4) long lasting (does not evaporate, break down, absorb significant water, or quickly dry out); and 5) eco-friendly (does not contaminate environment, completely bio-degradable). This is a fuel source that can be created almost anywhere that biomass grows in sufficient volume to harvest.

From the EPPM, sales/distribution 220 can be made to the following five (5) classes of customers shown in FIG. 2: localized biomass fuel depot 226; value added reseller (VAR) 224; local fuel suppliers 228; retail/wholesale outlets 230; and direct sales 227.

Localized Biomass Fuel Depot 226. Given that powdered biomass is safe to transport, store and does not “go bad,” it is a simple step for either the EPPM's or any local entrepreneur to build a facility for local storage and sales of powdered biomass by the ton. All that is required is either a building for storage or multiple silos and some basic handling equipment, all of which can be acquired quite inexpensively. Once a weighing system is in place, a basic fuel facility is available to meet the needs of local customers able to transport the fuel themselves which includes VAR's, local businesses, farms or just a weigh station between modules.

Value Added Reseller (VAR) 224. The VAR is the local company that sells and services end user furnaces, air conditioners, office buildings, etc. Since heating and cooling are their business, they are typically involved in all aspects of the business including the fuel supply itself. VARs will have their own customer base, technical staff and vehicle fleet. VAR's will be able to transport or order large quantities of powdered biomass from the EPPM locations, whichever is economically closest, providing the best price per ton of product. They will then have their own supply kept locally for their respective client base, ordering ahead based on demand.

Local Fuel Suppliers 228. Much like the local VAR, existing local fuel suppliers will likely want to be involved in the powdered biomass business. Most carry a variety of fuels including heating oil, propane and kerosene. Since powdered biomass is simple to store and transport by comparison, it is not a great or expensive leap to think the local fuel supplier will want to carry powdered biomass as one more product option. One will do it, others will follow. Additionally, they will provide the transportation link to local industrial contract customers.

Retail/Wholesale Outlets 230. With the advent of the “Superstore”, there is also the opportunity to sell fuel. Any place that feels comfortable selling wood pellets by the 50 or 80Lb bag and offer it by the ton, will most likely want to sell powdered biomass in the same quantities.

Direct Sales 227. There is the area of large industrial and commercial applications to consider. All large scale facilities use a variety of heating and cooling systems. Some utilize multiple solutions to be energy conscious and eco-friendly. These are becoming much more the norm due to volatile energy costs, and may likely turn out to be in the group of the EPPM's largest demand customers.

EPPM Franchising. Fundamental to the distribution model of the actual fuel is distribution and franchising by the EPPM's themselves. Since each EPPM would be locally owned and operated with a relatively moderate cost of entry, this is prime territory for entrepreneurs to start an energy business by purchasing franchise rights to an EPPM. All necessary equipment, product details including practical requirements and business structure can be licensed to a local entrepreneur or consortium for low cost, in order to facilitate a broad adoption of the powdered biomass technology. The broader the base, the more stable the overall structure. This approach assists in facilitating the fault tolerant design of the overall modular and networked production concept.

Enabling Demand. A crucial part of any business is enabling the demand for the product. If an EPPM and any of its distribution partners are to succeed, there must be a demand for the powdered biomass. If there is an ample supply of powdered biomass burners shipping from heating manufacturers through their own, existing distribution channel, the end-use demand will increase. However, if there is powdered biomass but no supply of energy conversion systems using powder burners, demand will be non-existent.

Therefore, the fuel and the end use energy conversion devices and their own supply chains work hand in hand. Both must be made available to the public and at a competitive pricing structure to facilitate the move from non-renewable heating oil, propane, or natural gas to renewable powdered biomass.

Manufacturers will be given a low cost license/lease allowing them to design and build powdered biomass burners and offer them through their existing sales channels. This low cost plan will encourage and enable the manufacturers to enter this new market competitively, with enough margin to be profitable in the short term, as well as on into the future.

Customer end use applications areas 232 are diagrammatically depicted at the bottom of FIG. 2. They include residential, commercial, industrial, agricultural, high energy fuels, transportation, unitized powder production systems, unitized heat-AC-power systems and remote site coverage 248-234.

### EXAMPLES

The mature bulk powder industry has lots of experience grinding a wide range of materials, but experience grinding with any significant throughput finer than the 30 mesh range, what is loosely mined “wood flour,” with cellulose and lignin based products is surprisingly limited. Tests processing wood chips, both hardwood and softwood, as well as corn stalks and dry manure solids have been run and continue to be investigated as part of a grant from NYSERDA.

Material quantities from 20 pounds to 500 pounds of these biomass sources, usually in the range of 20 mesh, have been shipped to the following companies to determine power requirements for given throughput rates for impact and attrition mill type reduction. These companies include Bauermeister, Munson Machinery, Classifier Milling Systems, and First American Scientific Corporation.

The effect of % moisture on throughput rate is extremely significant. For example, the KDS Micronex system from First American Scientific with a 400 HP main motor, fed with 55% moisture wet wood chips at 2080 lb/hr, produces about 1040 lb/hr of 10% moisture reduced product to explosible specification. However, if the input material has already been dried to 15% moisture, a full 5% above the EPPM mill specification, the rates improve substantially for a given power consumption rate of 300-340 KWhr per hour. A feed rate of 6000 lb/hr of the 15% moisture material results in about 4960 lb/hr of extremely low (i.e. 1%) moisture powder.

In an alternative embodiment, functions of the reduction steps, especially Step 2 and possibly Step 3, could be handled by a customized KDS Micronex System, as well as offer design options for lower mass flow rate EPPM's. Alternatively, using many of the design concepts in the present application, a mini-EPPM module can be provided to process this and other fuels on site or as an EPPM demand supplement, using a customized KDS Micronex technology available from First American Scientific Corp.

Some feedstock materials, corn stalks and grasses in particular, perform better when reduced well below the approximate explosibility threshold for wood of about 200 microns, roughly 70 mesh. A test run at Classifier Milling Systems provided very encouraging data that applies directly to the EPPM design for the fine grinding operation depicted in FIG. 8 from 800 through final classification 816 and titled Air Swept Pulverizing and Classifying Mill—Step 3.

With an input material of 80 mesh minus, the expected input for this Step 3, a particle size output distribution from one test was comprised of 92% smaller than 140 mesh, 6.5% between 140 and 100 mesh, and only 1% retained on the 100 mesh screen, a distribution expected at the Step 3 outputs 832 and 836. Scaling up the laboratory test, a system using 300 HP input can process about 1800 lb/hr of this very fine grind powder.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A method of preparing an explosible powder suitable for combustion in an oxidizing gas, said method comprising:
providing a biomass feedstock material;
drying the biomass feedstock material to a moisture level of less than or equal to 10%; and
milling the dried biomass feedstock material to form an explosible powder with a particle size distribution from about 50 to 200 microns, suitable for combustion by a standing deflagrating flame wave when dispersed in an oxidizing gas; and
combusting the explosible powder when dispersed in an oxidizing gas in a combustion enclosure by the standing deflagrating flame wave.

2. The method of claim 1, wherein said milling comprises:
subjecting the dried biomass feedstock material to a first hammer milling step to reduce the size of the dried biomass feedstock material to a product size of less than 5/16 inches in diameter;
subjecting the product of said first hammer milling to a second hammer milling step; and
screening the product of said second hammer milling to recover a classified product of about −80 mesh minus.

3. The method of claim 2, wherein said screening is carried out to remove elongated particles of proper diameter.

4. The method of claim 2 further comprising:
attrition milling the classified product of said second hammer milling and
air classifying the product of said attrition milling to recover a classified milled product.

5. The method of claim 4, wherein the air classified product has an upper size limit in the range of <140 to 200 mesh size to produce a classification milled product with a particle size distribution where less than 25 wt % of the particles have a size smaller than 325 mesh.

6. The method of claim 2, wherein the dried biomass feedstock with a size greater than +4 mesh is subjected to said first hammer milling and the dried biomass feedstock material with a size within the range of +80 to −4 mesh is subjected to said second hammer milling.

7. The method of claim 2 further comprising:
pelletizing the dried starting material with a size within the range of +30 to −6 mesh prior to said first or second hammer milling, the product of said first hammer milling with a mesh size of −6, or the product of said second hammer milling with a mesh size greater than +30 mesh.

8. The method of claim 1, wherein said providing the biomass feedstock material comprises:
subdividing the biomass feedstock material to a size of 5/16 to 2 inches in diameter and milling the subdivided biomass feedstock material to a size of less than 5/16 inches.

9. The method of claim 1, wherein said drying is carried out using heat resulting from combustion of the explosible powder in an oxidizing gas or production of biochar.

10. The method of claim 1 further comprising:
blending different explosible powders from different biomass feedstock materials or from different particle size distributions from a single biomass feedstock material, resulting from said method, to produce a blended explosible powder of a desired BTU value, particle size distribution, ash content, percent moisture, and combustion characteristics.

11. The method of claim 1, wherein the biomass feedstock material is selected from the group consisting of crops, wastes and residues, starch crops, grains, rice, barley, rye, oats, soybean, maize, wheat, sugar cane, sugar, cocoa bean, sugar crops, corn, grasses, industrial hemp, Giant reed, cotton, seeds, husks, seaweed, water hyacinth, algae, microalgae, herbaceous and woody energy crops, wood chips, bamboo, wood, stem wood, cellulose, lignin, hardwoods, American sycamore, black locust, eucalyptus, hybrid poplar, hybrid willow, silver maple, softwoods, cedar, pine, Monterey pine, invasive types of brush, fishmeal, fat, whey, agricultural wastes, rice straw, chaff, wheat straw, sugar cane bagasse, corn stover, corn stalks, biochar, forestal wastes, sawdust, shavings, lumber wastes, pulp and pulp waste, mill wastes, thinned woods, brush, municipal and industrial solid wastes, construction wastes, demolition wood wastes, urban wood wastes, yard wastes, agricultural residues, livestock wastes, dry manure solids, poultry wastes, intermediate enzymatic and acid hydrolysis bio-solid byproducts, waste solids from biological processes of ethanol fermentation, and methane production and anaerobic digested corn stalks.

12. The method of claim 1, wherein an additive comprising at least one material selected from the group consisting of boron, calcium, phosphorus, magnesium, silicon, sulfur, aluminum, iron, titanium, tantalum, zirconium, zinc, and compounds and alloys thereof, bronze, titanium dioxide, coal, ultra clean coal, metal, plastic, sulfur dust, phosphorus dust, polyester dust, a hydrocarbon-bearing solid, polypropylene, polystyrene, acrylonitrile butadiene styrene, polyethylene terephthalate, polyester, polyamides, polyurethanes, polycarbonate, polyvinylidene chloride, polyethylene, polymethyl methacrylate, polytetrafluoroethylene, polyetheretherketone, polyetherimide, phenolics, urea-formaldehyde, melamine formaldehyde, or polylactic acid is added to the biomass feedstock material.

13. The method of claim 1, wherein coal or biochar are added to the biomass feedstock material.

14. The method of claim 1, wherein the biomass feedstock material comprises a blend of a plurality of different types of biomass.

15. The method of claim 1 further comprising:
classifying the milled dried biomass feedstock and
repeating, after said classifying, said milling of the milled dried biomass feedstock which is not at the desired size of an explosible powder.

16. The method of claim 1, wherein the explosible powder resulting from said milling has an ash content of less than or equal to 6 wt %.

17. The method of claim 16 wherein the explosible powder resulting from said milling has an ash content of less than or equal to 1 wt %.

18. The method of claim 1, wherein the explosible powder resulting from said milling has less than about 5 wt % of its particles with a size larger than an explosibility limit.

19. The method of claim 1, wherein the explosible powder resulting from said milling comprises particles having a particle size distribution median so that less than about 5 wt % of the particles have a size greater than an explosibility limit.

20. The method of claim 1, wherein the explosible powder resulting from said milling has a particle size distribution where less than about 5 wt % of the particles by weight have a size larger than or equal to 80 mesh and at least about 15% of the particles by weight have a size smaller than 200 mesh.

21. The method of claim 1, wherein the explosible powder resulting from said milling has a particle size distribution where less than 1% of the particles by weight have a size larger than or equal to 200 mesh.

22. method of claim 1, wherein less than about 5wt % of the particles of the explosible powder have a size larger than or equal to 200 mesh.

23. The method of claim 1, wherein at least 30wt % of the particles of the explosible powder have a size smaller than 200 mesh.

24. The method of claim 23, wherein at least 30wt % of the particles of the explosible powder have a size smaller than 325 mesh.

25. The method of claim 23, wherein at least 40wt % of the particles of the explosible powder have a size smaller than 200 mesh.

26. The method of claim 1, wherein less than 1 wt % of the particles of the explosible powder have a size larger than or equal to 80 mesh.

27. The method of claim 26, wherein substantially all of the particles of the explosible powder have a size smaller than or equal to 80 mesh.

28. The method of claim 1 further comprising:
blending the biofeedstock material with the dried biomass feedstock during said milling.

29. The method of claim 1 wherein the biomass feedstock material is a biochar.

30. The method of claim 1 wherein the explosible powder has a particle size distribution with a mean of about 50-80 microns.

31. A method of preparing an explosible powder suitable for combustion in an oxidizing gas, said method comprising:
providing a biomass feedstock material; and
milling the biomass feedstock material to form an explosible powder with a particle size distribution from about 50 to 200 microns, suitable for combustion by a standing deflagrating flame wave when dispersed in an oxidizing gas; and
combusting the explosible powder when dispersed in an oxidizing gas in a combustion enclosure by the standing deflagrating flame wave.

32. The method of claim 31 wherein the biomass feedstock material is a biochar.

33. The method of claim 31 wherein the explosible powder has a particle size distribution with a mean of about 50-80 microns.
